(19) United States
(12) Patent Application Publication
(10) Pub. No.: US 2015/0125768 A1
(43) Pub. Date: May 7, 2015

(54) Cell and Cell Block Configurations for Redox Flow Battery Systems

(71) Applicant: EnerVault Corporation, Sunnyvale, CA (US)

(72) Inventors: Ronald J. MOSSO, Fremont, CA (US); Jay E. SHA, Mountain View, CA (US); Kurt RISIC, Mountain View, CA (US); Bruce LIN, Mountain View, CA (US); Jeremy P. MEYERS, Austin, TX (US)

(21) Appl. No.: 14/535,236

(22) Filed: Nov. 6, 2014

Related U.S. Application Data
(60) Provisional application No. 61/901,160, filed on Nov. 7, 2013.

(51) Int. Cl. H01M 8/24; H01M 8/18; H01M 8/04; H01M 8/20

(52) U.S. Cl. CPC H01M 8/246; H01M 8/20; H01M 8/188; H01M 8/04276
USPC 429/418

(57) ABSTRACT

Embodiments of an electrochemical flow cell stack are disclosed. A plurality of frame layers may each have a peripheral gasket channel configured to receive a gasket material. The gasket channel may surround a recessed area having a size and a structure configured to receive an insert layer. Each of the plurality of frame layers may include at least one void area defining a first half-cell chamber of a flow cell. A plurality of insert layers may each be nested within a corresponding frame layers. Each insert layer may include at least one void area defining a second half-cell chamber of the flow cell. A flow cell may be formed by one of the plurality of frame layers and one of the plurality of insert layers.

### CROSS REFERENCE TO RELATED APPLICATIONS

The present application claims the benefit of priority to U.S. Provisional Application No. 61/901,160 entitled “CELL AND CELL BLOCK CONFIGURATIONS FOR REDOX FLOW BATTERIES,” filed on Nov. 7, 2013, the entire contents of which are incorporated by reference herein.

### STATEMENT OF FEDERALLY FUNDED RESEARCH

Inventions included in this patent application were made with Government support under DE-OE0000225 “Recovery Act—Flow Battery Solution for Smart Grid Renewable Energy Applications” awarded by the US Department of Energy (DOE). The Government has certain rights in these inventions.

### FIELD

This invention generally relates to electrochemical flow systems, and more particularly to configurations of reaction cells and cell blocks within electrochemical flow systems.

### BACKGROUND

Redox Flow Batteries (RFBs) are rechargeable systems in which the electrochemical reactants are dissolved in liquid electrolytes. The electrolytes, which are stored in external tanks, are pumped through a stack of reaction cells where electrical energy is alternately converted to and extracted from chemical energy in the reactants by way of reduction and oxidation reactions.

Redox flow battery systems provide substantial flexibility as energy storage capacity may be expanded by increasing tank sizes. Output power of a flow battery system may be expanded by increasing the number and/or size of electrochemical reaction cells. Reaction cells may be arranged into blocks or stacks containing multiple cells.

### SUMMARY

Thus in various embodiments, methods and systems are provided for configuring an electrochemical flow stack having various advantageous features. Embodiments of an electrochemical flow cell stack may comprising a plurality of frame layers, each of the plurality of frame layers having a peripheral gasket channel configured to receive a gasket material therein. The gasket channel may surround a recessed area having a size and a structure configured to receive an insert layer. Each of the plurality of frame layers may have at least one void area defining a first half-cell chamber of a flow cell. Further in embodiments, an electrochemical flow cell stack may have a plurality of insert layers, each of the plurality of insert layers being nested within a corresponding one of the plurality of frame layers. Each of the plurality of insert layers may have at least one void area defining a second half-cell chamber of the flow cell formed by one of the plurality of frame layers and one of the plurality of insert layers.

In embodiments, each of the plurality of frame layers may further include a plurality of openings defining inlet/outlet ports and at least a first channel defining a first flow path joining a first one of the plurality of openings defining the inlet/outlet ports to the first half-cell chamber and at least a second channel defining a second flow path joining the first half-cell chamber to a second one of the plurality of openings defining the inlet/outlet ports.

In embodiments, each of the plurality of insert layer may have a third channel defining a third flow path joining a third one of the plurality of openings defining the inlet/outlet ports to the second half-cell chamber and a fourth channel defining a fourth flow path joining the second half-cell chamber to a fourth one of the plurality of openings defining the inlet/outlet ports.

In embodiments, each of the plurality of insert layers and each of the recessed areas of the plurality of frame layers may be configured with a size and a shape such that each of the plurality of insert layers nests within corresponding ones of the plurality of frame layers in a single orientation.

In embodiments, each of the plurality of frame layers may have one or more flat surfaces surrounding the first channel, the one or more flat surfaces configured to seal against one or more adjacent structures in the electrochemical stack. Further in embodiments, the one or more adjacent structures may include one or more separator layers or one or more bipolar plate layers.

In embodiments, an electrochemical flow cell stack may also have a pair of structural base plates and a pair of structural clamping plates configured to secure the plurality of frame layers and the plurality of insert layers. Further in embodiments, an electrochemical flow cell stack may have a pair of sealing monopolar plate layers adjacent to the pair of structural base plates. In embodiments, the pair of sealing monopolar plate layers may be constructed from a non-reactive electrically conductive material that is impermeable to an electrolyte.

Further in embodiments, an electrochemical flow cell stack may have a first porous electrode positioned in the first half-cell chamber of each of the plurality of frame layers and a second porous electrode positioned in the second half-cell chamber of each of the plurality of insert layers. Further in embodiments, the first porous electrode may have a thickness greater than a thickness of one of the plurality of frame layers. Further in embodiments, the first porous electrode may be compressible such that a thickness of first porous electrode is reduced by compression when each of the plurality of frame layers and each of the plurality of insert layers are compressibly joined into a clamped configuration.

Further in embodiments, each of the plurality of frame layers and each of the plurality of insert layers may have at least one registration feature configured to align each of the plurality of insert layers relative to each of the plurality of frame layers.

Further in embodiments, an electrochemical flow cell stack may have a first electrode section positioned in the first half-cell chamber of each of the plurality of frame layers and a second electrode section positioned in the second half-cell chamber of each of the plurality of insert layers. Further in embodiments, an electrochemical flow cell stack may have a separator layer positioned between the first half-cell chamber of each of the plurality of frame layers and the second half-cell chamber of each of the plurality of insert layers. Further in embodiments, an area dimension of the first electrode section and the second electrode section may be substantially the same as an area dimension of an active area section of the separator layer.

Further in embodiments, the first half-cell chamber of each of the plurality of frame layers may be divided into a first sub-cell section and a second sub-cell section by a plenum channel, and the first sub-cell section may have a first porous electrode section and the second sub-cell section may have a second porous electrode section. Further in embodiments, each of the plurality of frame layers may have a first lateral channel adjacent to the first sub-cell section and a second lateral channel adjacent to the second sub-cell section. Further in embodiments, the plenum channel may have at least one flange extending into at least one of: the first sub-cell section and the second sub-cell section. Further in embodiments, at least one of the first lateral channel and the second lateral channel may have a flange extending into a respective at least one of the first sub-cell section and the second sub-cell section.

Further in embodiments, an electrochemical flow cell stack may have a separator layer having one or more active areas made of a semi-permeable membrane material and one or more inactive areas made of an impermeable material, and the one or more active areas may be configured to align with the first and second sub-cell sections. Further in embodiments, the semi-permeable membrane material of the one or more active areas may be bonded to the impermeable material of the one or more inactive areas by heat sealing.

Further in embodiments, a dimension of the first porous electrode section and the second porous electrode section may have substantially the same dimensions as the one or more active areas made of the semi-permeable membrane material.

Further in embodiments, an electrochemical flow cell stack may have a plenum channel having a central support rib. Further in embodiments, each of the plurality of frame layers may include a voltage test tab configured to provide an electrical connection to the first half-cell chamber.

Further in embodiments, an electrochemical flow cell stack may have a first structural end plate, a first base layer positioned adjacent to and in contact with the first structural end plate. The first base layer may have an outer peripheral gasket channel configured to receive a gasket material therein, and the outer peripheral gasket channel may surround a recessed area having a size and a structure configured to receive an insert layer. Further in embodiments, an electrochemical flow cell stack may have a first insert layer nested within the recessed area of the first base layer. The first insert layer may have at least one void area defining at least a portion of a first half-cell chamber of the first flow cell.

Further in embodiments, an electrochemical flow cell stack may have a first frame layer positioned adjacent to and in contact with at least portions of the first base layer and the first insert layer. The first frame layer may have an outer peripheral gasket channel configured to receive a gasket material therein. The gasket channel may surround a recessed area having a size and a structure configured to receive an insert layer. The frame layer may have at least one void area defining at least a portion of a second half-cell chamber of the first flow cell.

Further in embodiments, an electrochemical flow cell stack may have a second insert layer nested within the recessed area of the first frame layer, the second insert layer may have at least one void area defining at least a portion of a first half-cell chamber of a second flow cell. Further in embodiments, an electrochemical flow cell stack may have an Nth frame layer, where N is equal to the number of electrochemical cells in the stack. Further in embodiments, an electrochemical flow cell stack may have a second base layer positioned adjacent to and in contact with the Nth frame layer and a second structural end plate positioned adjacent to and in contact with the second base layer.

Further in embodiments, an electrochemical flow cell stack may have a first impermeable electrically conductive monopolar plate layer positioned between the first base layer and the first insert layer and sealing the first half-cell chamber from the first base layer.

Further in embodiments, an electrochemical flow cell stack may have a first separator layer sandwiched between the first insert layer and the first frame layer and having at least one semi-permeable active area section separating the first half-cell chamber from the second half-cell chamber. In embodiments, the first separator layer further may have one or more impermeable sections configured to seal one or more flow channels in at least one of the first insert layer and the first frame layer.

Further in embodiments, an electrochemical flow cell stack may have a first impermeable electrically conductive layer sandwiched between the first frame layer and the first insert layer, the first impermeable electrically conductive layer may seal at least one flow channel in at least one of the first frame layer and the first insert layer. In embodiments, the first insert layer may have a plenum channel dividing the first half-cell chamber into two sub-cell sections and first and second lateral flow channels across the sub-cell sections from the plenum channel.

Various embodiments are also provided herein for configuring a composite electrochemical separator. Some embodiments of a composite electrochemical separator may include a sheet of impermeable material with a first separator cutout section and a second separator cutout section, each of the first and the second separator cutout sections being entirely surrounded by a perimeter of the impermeable material. Further in embodiments, the composite electrochemical separator may have a first sheet of semi-permeable material and a second sheet of semi-permeable material bonded to the perimeter of impermeable material surrounding the first separator cutout section and the second separator cutout section of the impermeable material sheet.

In some embodiments, the semi-permeable material may comprise a micro-porous membrane material. Further in embodiments, the semi-permeable material may comprise an ion-selective membrane material.

Further in embodiments, the sheet of impermeable material may have inlet/outlet cutouts, each of which may be entirely surrounded by at least some of the impermeable material. Further in embodiments, the sheet of impermeable material may have a substantially rectangular shape and the inlet/outlet cutouts may be positioned adjacent each of the four corners of the rectangular shape.

Further in embodiments, the sheet of impermeable material may have positioning holes adjacent corners of the sheet of impermeable material, wherein the positioning holes may be arranged so as to not intersect the inlet/outlet cutouts.

Embodiments of an electrochemical flow cell stack may also include a first structural end plate and a first base layer positioned adjacent to and in contact with the first structural end plate. The first base layer may have an outer peripheral gasket channel configured to receive a gasket material therein, and the gasket channel may surround a recessed area having a size and a structure configured to receive an insert layer. Further in embodiments an electrochemical flow cell stack may have a first frame layer positioned adjacent to and in contact with at least portions of the first base layer and the first insert layer. The first frame layer may have an outer peripheral gasket channel configured to receive a gasket material therein, and the gasket channel may surround a recessed area having a size and a structure configured to receive an insert layer. Further in embodiments, an electrochemical flow cell stack may have a frame layer comprising at least one void area defining at least a portion of a first half-cell chamber of the first flow cell, and a first insert layer nested within the recessed area of the first frame layer. The first insert layer may have at least one void area defining at least a portion of a second half-cell chamber of the first flow cell. The first insert layer may also have a plenum channel dividing the first half-cell chamber into two sub-cell sections.

Further in embodiments, an electrochemical flow cell stack may have a first separator layer sandwiched between the first insert layer and the first frame layer and having at least one semi-permeable active area section configured to separate the first half-cell chamber from the second half-cell chamber. The first separator layer may have impermeable sections sealing at least one of the plenum channel and a flow channel in at least one of the first insert layer and the first frame layer.

Further in embodiments, an electrochemical flow cell stack may have a first impermeable electrically conductive layer positioned adjacent to and in contact with the first insert layer. The first impermeable electrically conductive layer may be configured to seal and enclose at least one of the first and the second lateral flow channel in the first insert layer.

Further in embodiments, an electrochemical flow cell stack may have an Nth frame layer, where N is equal to the number of electrochemical cells in the stack, a second base layer positioned adjacent to and in contact with the Nth frame layer, and a second structural end plate positioned adjacent to and in contact with the second base layer.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a schematic diagram illustrating a redox flow battery example of an electrochemical flow system.

FIG. 2A is a diagram illustrating a cross-sectional view of a single electrochemical flow cell.

FIG. 2B is a diagram illustrating a cross-sectional view of a block of multiple electrochemical flow cells in a bipolar stack.

FIG. 3A is a diagram illustrating a top-view of a base frame layer in embodiments of a cell stack.

FIG. 3B is diagram illustrating a close-up view of a portion of a top side of a base layer showing examples of registration features.

FIG. 4A is a diagram illustrating a bottom-view of a base frame layer in embodiments of a cell stack.

FIG. 4B is a diagram illustrating a close-up view of a portion of a bottom side of a base layer and showing examples of registration features.

FIG. 4C is a diagram illustrating a close-up view of a portion of an insert layer with structures nesting into structures of a corresponding portion of a frame layer.

FIG. 4D is a diagram illustrating a close-up view of a portion of an insert layer with structures nested into structures of a corresponding portion a frame layer.

FIG. 5 is a diagram illustrating a top-view of an insert layer in embodiments of a cell stack.

FIG. 6 is a diagram illustrating a bottom-view of an insert layer in embodiments of a cell stack.

FIG. 7A is a diagram illustrating an alternative top-view of an insert layer in embodiments of a cell stack.

FIG. 7B is a cross-sectional perspective view illustrating an example of a plenum separating two active electrode regions in a half-cell.

FIG. 7C is a cross-sectional perspective view illustrating an example of a lateral flow channel at a lateral edge of an electrode region in a cell.

FIG. 8A is a diagram illustrating an example of a separator layer.

FIG. 8B is a diagram illustrating a partially-assembled cell stack including a separator layer and a frame layer.

FIG. 9 is a diagram illustrating a bottom view of a base plate in embodiments of a cell stack.

FIG. 10 is a diagram illustrating a top view of a base plate in embodiments of a cell stack.

FIG. 11A is a diagram illustrating a top view of a base plate in embodiments of a cell stack having a metal support plate.

FIG. 11B is a diagram illustrating a top view of an alternatively configured base plate.

FIG. 12 is a diagram illustrating a top view of a base plate in embodiments of a cell stack with a conductive end plate over the support plate.

FIG. 13 is a diagram illustrating a top view of a base plate in embodiments of a cell stack including a conductive current collector layer over the conductive end plate.

FIG. 14 is a diagram illustrating a top view of a base plate in embodiments of a cell stack including an insert layer nested in the base plate and over the current collector layer.

FIG. 15 is a diagram illustrating a top view of a base plate of an embodiment of a cell stack including an insert layer nested in the base plate and electrode segments placed over the current collector layer.

FIG. 16A is a diagram illustrating a top view of a base plate in embodiments of a cell stack including an insert layer nested in the base plate and a separator layer placed over the electrode segments.

FIG. 16B is a diagram illustrating a close-up view of a portion of a separator layer positioned in relation with structures of corresponding portions of a frame layer and an insert layer.

FIG. 17 is a diagram illustrating a frame layer being placed on a base plate assembly as in FIG. 16A.

FIG. 18 is a diagram illustrating a top view of a frame layer placed over a separator layer.

FIG. 19 is a diagram illustrating electrode segments being placed into electrode chambers in a frame layer.

FIG. 20 is a diagram illustrating a bipolar plate layer that has been positioned over a frame layer and electrode segments as in FIG. 19.

FIG. 21 is a diagram illustrating an insert layer nested into a frame layer over a bipolar plate layer as in FIG. 20.

FIG. 22 is a diagram illustrating a perspective partial view of a stacked assembly as in FIG. 21.

FIG. 23 is a diagram illustrating a bottom view of a cap plate in embodiments of a cell stack.

FIG. 24 is a diagram illustrating a top view of a structural end plate in embodiments of a cell stack.

FIG. 25 is a diagram illustrating a perspective view of a stack including two electrochemical flow cells in various embodiments.

FIG. 26 is a diagram illustrating a close-up view of an example of a terminal for monitoring an electrical parameter of a cell.

FIG. 27 is a diagram illustrating a cross-sectional perspective view of portions of several cell layers of an example cell stack.

FIG. 28 is a diagram illustrating a perspective cross-sectional view of a portion of a nesting cell-stack structure as in FIG. 29.

FIG. 29 is a diagram illustrating a cross-sectional view of an alternate configuration of a nesting cell-stack structure having separate low pressure and high-pressure seals in various embodiments.

FIG. 30 is a diagram illustrating an alternate shape of a plenum support rib in various embodiments.

### DETAILED DESCRIPTION

The various embodiments will be described in detail with reference to the accompanying drawings. References made to particular examples and implementations are for illustrative purposes, and are not intended to limit the scope of the invention or the claims.

The various embodiments below provide improved electrochemical cell and stacked cell block structures that may improve operating efficiency and other performance metrics in electrochemical flow systems such as flow batteries, electrosysnthesis systems, and others. In some embodiments, flow-through electrochemical cells with a large active surface area may be divided into multiple active sections, such as two active sections separated by a flow-directing plenum. This configuration may allow for improved electrolyte flow and decreased pressure gradients within cells and cell blocks while maintaining a large active surface area. In some cases, positive and negative half-cells of such a divided active area cell may be separated by a composite separator layer that includes one or more permeable or semi-permeable sections that allow ions to diffuse from one half-cell to the other in active cell areas. Permeable or semi-permeable separator sections may be bonded to an impermeable material configured to prevent passage of ions or liquid from one half-cell to the other in inactive regions of the cell. Other embodiments may provide improved structures for sealing fluid-containing portions of adjacent half-cells while also sealing a stack against external leaks.

Certain terms that are used throughout the application are explained here. Other terms that appear less frequently are explained as they arise.

As used herein, the terms “about” or “approximately” for any numerical values or ranges indicates a suitable temperature or dimensional tolerance that allows the part or collection of components to function for its intended purpose as described herein.

The term electrochemical flow system (or ECFS) may include redox flow batteries (“RFBs”) which may include electrochemical energy storage systems in which one or more fluid electrochemical reactants may be flowed through a reaction cell in which electrical energy may be converted to and/or from chemical energy. Electrochemical flow systems may also include electrosysnthesis systems in which chemical elements or compounds may be synthesized, purified or otherwise changed through electrochemical processes as one or more fluid (e.g., gas, liquid, slurry, colloidal dispersion, etc.) reactant is flowed through one or more flow-through electrochemical reaction cells.

The term semi-permeable membrane as used herein may refer to any semi-permeable membrane, selectively permeable membrane, partially permeable membrane, or differentially permeable membrane, as understood by those skilled in the art. For example, the term semi-permeable membrane may refer to any membrane material that will allow certain molecules or ions to pass through it by diffusion while preventing other molecules from passing through. In various embodiments of electrochemical flow systems, semi-permeable separator membranes may be ion-selective membranes such as Nafion, or microporous membranes which are not necessarily ion-selective. Microporous membranes may include microporous membrane separators manufactured by Celgard LLC, and membrane separators made by Daramic LLC. In some cases, the term “permeable” may be used herein to refer to materials that are not entirely impermeable, and may include both highly permeable materials and semi-permeable materials. Impermeable materials may include any materials that are substantially impermeable to any of the molecules or ions involved in the electrochemical flow system some examples of impermeable materials for particular aspects of an electrochemical flow system are described below.

As used herein, the terms “optimized,” “optimum” and similar variants are merely intended to indicate relative quantitative or qualitative improvements to performance or other variables. Use of these terms is not intended to imply or require that such factors are necessarily designed for the best possible or theoretical performance. The terms may alternatively or additionally refer to a configuration that achieves a degree of performance, such as a specific or predetermined degree of performance that will have beneficial effects in the configured part or other parts of the system.

Unless otherwise specified, the terms anolyte and catholyte are used herein as if the battery were always in a discharge mode. Hence, the term “anolyte” will refer to the electrolyte in contact with the negative electrode of an electrochemical reaction cell and the term “catholyte” will refer to the electrolyte in contact with the positive electrode of an electrochemical reaction cell.

As used herein, the phrase “state of charge” and its abbreviation “SOC” refer to the instantaneous ratio of useable to theoretical stored electrical charge (measured in ampere-hours). The terms may be applied either to the charge storage capacity of a complete RFB system or to electrolytes within a particular component of the RFB. “Useable” charge may refer to stored charge that may be delivered at or above a threshold voltage (e.g. about 0.7 V in some embodiments of Fe/Cr RFB systems).

The energy produced or consumed by an electrochemical cell can be expressed as the product of cell voltage, current and time (Joules=Volts×Amps×Seconds). Energy losses within the cell can arise from two distinct effects, known as “Voltage efficiency” and “Faradaic efficiency”.

Voltage efficiency falls below unity when the measured cell voltage deviates from the theoretical potential difference (the so called “thermodynamic reversible potential”) for that cell. The magnitude of the voltage deviation is known as the cell “overpotential” and in general the overpotential includes contributions from energy losses at each electrode. The overpotential at the cell anode (i.e., the electrode at which oxidation is occurring) has a positive sign, while the overpotential at the cell cathode (i.e., the electrode at which reduction is occurring) has a negative sign. Hence, on charge, the two overpotentials combine to increase the cell voltage (wasting some of the input energy) and on discharge, they combine to decrease the cell voltage (wasting some of the output energy).

As used herein, the term “Faradaic efficiency” refers to the proportion of the electric current flowing at an electrode that achieves the intended oxidation or reduction reaction. A Faradaic efficiency of unity means that none of the current is wasted on parasitic reactions (defined below). In RFBs, Faradaic efficiencies smaller than unity can arise from an inadequate supply (or “flux”) of redox reagent to the electrode surface or imperfect selectivity for the preferred reaction.

As used herein, the terms “stoich” and “stoich flow” refer to the ratio of the flux of a redox reactant entering an electrochemical cell (or cell module) to the rate at which the reactant is consumed in the cell (or cell module). The reactant flux depends on both the concentration of the reactants in the electrolytes and the flow rate of the electrolytes into the cell. The rate at which reactants are consumed depends on the electric current supplied to the cell (during charging) or drawn from the cell (during discharge).

To illustrate the meaning of stoich, we may consider a cell that is being supplied with 10⁻⁴ mole per second of the reactant Fe³⁺, which is being consumed in the reduction reaction expressed in EQ(1):

Fe³⁺+e⁻=Fe²⁺ EQ(1)

A current of 10⁻⁴ moles per second of electrons (e.g., 10⁻⁴ Faraday per second or approximately 9.65 amps) provides electrons at a rate and molar concentration equal to the supply of the reactant. Hence a current of the above noted magnitude would give a stoich value of unity in the cell. Similarly, a current of half the above noted magnitude would result in a reduced rate of consumption of the reactant giving a stoich value of 2.0.

Like Faradaic efficiency, stoich is a dimensionless quantity and the term applies to both charging and discharging reactions. For these and other reasons, stoich values substantially greater than unity may be required to prevent significant losses in Faradaic efficiency.

When the Faradaic efficiency at one or both electrodes in a cell falls below unity, the electrode or electrodes can be driven into overpotential ranges where “parasitic” electrode reactions arise to make up the deficit in Faradaic current. For example, in the Fe/Cr RFB, low stoich conditions in the negative electrolyte during charge can drive the electrode potential low enough to initiate hydrogen evolution via the electrode reaction expressed in EQ(2):

2H⁺+2e⁻=H₂. EQ(2)

Similarly, low stoich conditions in the positive electrolyte during charge can drive the electrode potential high enough to initiate chlorine evolution via the electrode reaction expressed in EQ(3):

2Cl⁻═Cl₂+2e⁻ EQ(3)

Parasitic reactions can also arise when low stoich conditions develop during discharge.

All of the charge consumed in parasitic reactions subtracts directly from the “useable” charge stored by the battery. As used herein, the term “useable” charge refers to stored charge that may be delivered at or above a threshold voltage (e.g. about 0.7 V in some embodiments of the Fe/Cr RFB system).

### Introduction to ECFS Systems and Components

FIG. 1 depicts basic components of a flow battery, such as a 2-tank recirculating electrochemical flow system 10 utilizing two flowing fluid reactants. In addition to at least one storage tank 11 for each reactant, the system 10 may include pumps 12 for circulating the reactants and an electrochemical reaction cell stack 14. For electrolytic reactions (e.g., a charging reaction), an applied electric current may be supplied by a power source 16 and for galvanic reactions (e.g., a discharging reaction), a produced electric current may pass through a load 18. In various embodiments, the electrochemical reaction cell stack 14 may include a number of individual electrochemical flow cells grouped into a common structure in a bipolar configuration.

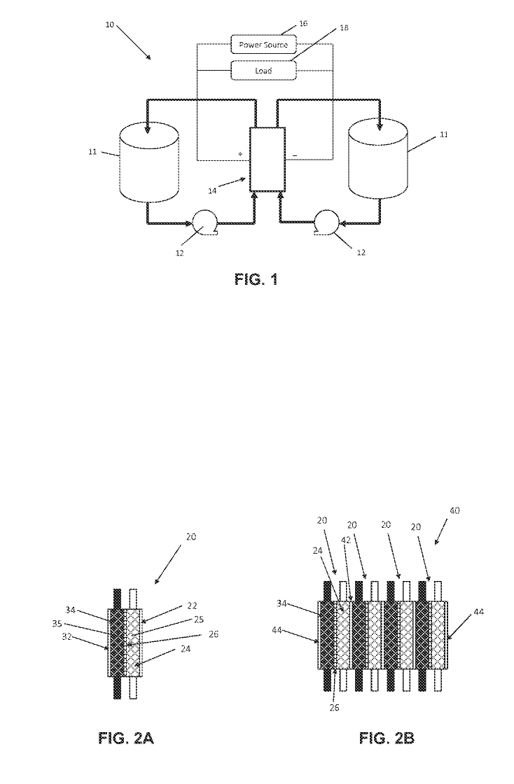

FIG. 2A illustrates components of a single flow-through reaction cell 20. The single flow-through reaction cell 20 may include a positive current collector 22, such as a current collector plate, and a positive electrode 24 in a positive half-cell chamber 25. The single flow-through reaction cell 20 may further include a negative current collector 32, such as a current collector plate, and a negative electrode 34 in a negative half-cell chamber 35. In some configurations, the current collector and electrode may be a single structure rather than two separate structures as shown. The positive half-cell chamber 25 and the negative half-cell chamber 35 may be separated by a separator 26. The separator 26 may generally be any porous or ion selective membrane material needed for a particular application. Various separator materials suitable for use in an electrochemical flow cell are available and known to those skilled in the art.

In some cases, the positive and negative electrodes 24, 34 may comprise a porous electrically conductive material configured to allow a fluid reactant to flow through the chamber while conducting electrical currents to the positive and negative current collectors 22, 32. Such electrode materials may include carbon or graphite felt or other porous matrix carbon or graphite materials. In some cases, electrodes may comprise metallic materials formed into felt, braids, or other structures suitable for flowing electrolyte through. Terms such as “electrode,” “felt,” or “electrode felt” may be used herein to refer to any suitably configured flow-through conductive structure.

In some cases, metallic electrodes may be entirely made of or coated with a non-reactive or positively-reactive surface layer. Depending on the intended application of the flow system, the electrodes may comprise other reactive and/or non-reactive materials. Current collector plates may generally be made of any material with a suitable combination of electrical conductivity, reactivity (or non-reactivity) with electrolytes, and structural strength/flexibility. Such materials may include carbon plates, carbon-impregnated polymer materials or others.

A single electrochemical cell may provide a limited voltage or limited processing capacity. In order to increase the voltage of a system, a plurality of cells may be combined in an electrically series-connected configuration. FIG. 2B depicts a stack 40 of four of the single flow-through reaction cells 20 in a bipolar configuration. The electrically conductive inner current collectors 42, such as current collector plates, in between adjacent ones of the single flow-through reaction cells 20 may act as bipolar plates joining a positive end of one cell to a negative end of an adjacent cell. Such a bipolar arrangement may create an electrical series connection from one cell to the next. Outer current collectors 44, such as current collector plates may be positioned at the ends of the stack 40. Thus, due to the electrical series connection between adjacent ones of the single flow-through reaction cells 20, the current collectors 44 at the outside ends of the stack 40 may have opposite polarities.

During operation, the reactants may undergo reduction and oxidation reactions as the fluid reactants pass through and contact the positive and negative electrodes 24 and 34 respectively, generating or consuming DC power. In a recirculating system (an example of which is shown FIG. 1), electrolytes may pass through the stack 40 multiple times, progressively increasing or decreasing the proportion of charged redox reactants in the electrolytes with each fluid pass through the stack 40. A charging operation may be performed by circulating electrolytes through the stack while applying an electric current from a power source (e.g., from a solar cells array or other power source). Similarly, a discharging reaction may be performed by circulating the electrolytes through the stack 40 while directing an electric current produced by reactions within the stack to a load.

In other electrochemical flow system architectures, electrolytes may be fully discharged in a single fluid pass through the cell stack and the spent electrolytes may be collected in separate tanks (for a total of at least four separate tank volumes). An effective implementation of this single pass (or “4-tank”) architecture is a cascade flow stack in which electrolytes pass through a series of stages, each of which incrementally increases or decreases the state-of-charge of electrolytes.

A variation of the cascade ECFS architecture is an engineered cascade in which cells, stages and/or arrays within the battery are configured to increase the battery's performance over that achievable in a cascade RFB in which all cells, stages and/or arrays along the reactant flow path are substantially the same as one another. For example, within an engineered cascade RFB, each cascade stage may be tailored to a specific SOC range. Various examples of such engineered cascade RFB systems are provided in U.S. Patent Application Publication No. 2011/0223450, which is incorporated in its entirety herein by reference.

The term “engineered cascade” is used herein to refer generally to a cascade ECFS in which cells, stages and/or arrays within the battery are configured in terms of materials, shapes and sizes, reactant flow, and/or other variables based on an expected condition of reactants. The engineered cascade may be configured, for example, to achieve a range of electrolyte SOC to be experienced by the cells so as to increase the battery's performance. Performance parameters such as round trip energy efficiency, power output, reduced electrolyte breakdown, reduced hydrogen generation, improved safety, decreased material degradation, or other performance metric may be advantageously increased over that achievable in a cascade ECFS in which all cells, stages and/or arrays along the reactant flow path are substantially the same as one another.

U.S. Patent Application Publication No. 2011/0223450 provides several examples of possible configurations for individual flow battery cells, blocks containing multiple cells, and stacks containing multiple cell blocks. The embodiments set forth herein, and other embodiments, may be used in combination with any of the systems disclosed in U.S. Patent Application Publication No. 2011/0223450 or other available systems.

### Nested Cell Stack Construction

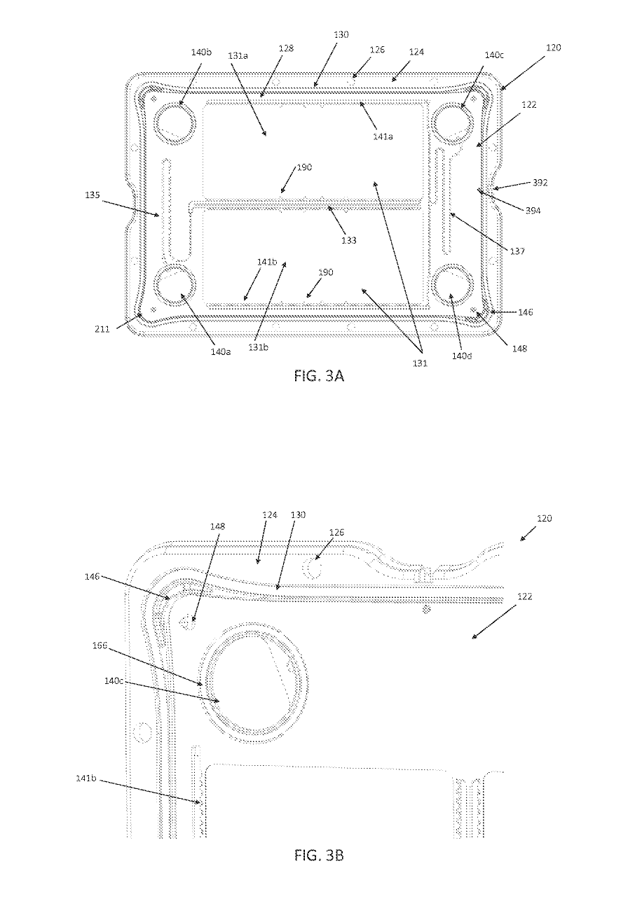

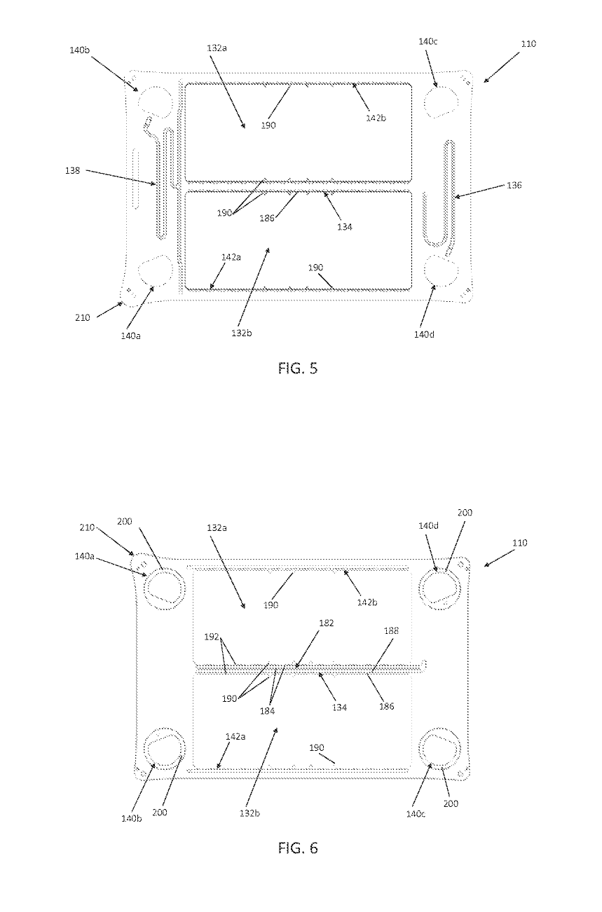

FIG. 3A through FIG. 30 show examples of various aspects of a nested cell stack configuration. With reference to FIG. 3A and FIG. 5, a nested cell stack configuration may comprise a plurality of cell insert layers 110 (FIG. 5) nested within respective cell frame layers 120 (FIG. 3A). A cell frame layer 120 may be configured to receive an insert layer 110 in a nested arrangement as shown in various figures including, for example, FIG. 21.

In some embodiments, frame layers and insert layers may be injection molded or otherwise molded from a suitable material such as nylon, high density polyethylene, low density polyethylene, polyvinyl chloride, chlorinated polyvinyl chloride, or other moldable or machinable thermoplastic or thermoset plastic or composite materials. Alternatively, frame layers and insert layers may be molded or machined from plastics, metals, carbon, or other materials selected or treated to be impervious to corrosive electrolytes.

With reference to FIG. 3A and FIG. 5, in some cases, both the cell frame layer 120 and the insert layer 110 may include voids or half cell chambers 132 for receiving electrode materials. In some cases, the cell frame layer 120 and the insert layer 110 may include low-cost injection molded components.

FIG. 3A shows a top surface 122 of a cell frame layer 120 comprising several notable features. The cell frame layer 120 may comprise a border section 124 with a plurality of through holes, such as bolt holes 126 for receiving clamping bolts, as described in greater detail herein below. The cell frame layer 120 may also include an internal section 128 that is recessed or lowered relative to the border section 124. The internal section 128 may be separated from the border section 124 by a gasket channel 130 which may surround the entire periphery of the internal section 128. The internal section 128 may include at least one of the half-cell chambers 132 which may be a single half-cell chamber section, or may be divided into multiple sub-cell sections by one or more plenum structures such as plenum channels 133.

The cell frame layer 120 of FIG. 3A shows an area having two separate regions, such as a first sub-cell section 132a, and a second sub-cell section 132b, which may be separated by a plenum channel 133. The sub-cell sections 132a and 132b may also be referred to herein as electrode sections, because porous electrodes may generally be positioned within the sub-cell sections 132a and 132b in a final stacked assembly, as will be described in further detail below.

The internal section 128 may also include a first shunt channel 135 providing a fluid path between a first corner port 140a and the plenum channel 133. A second shunt channel 137 may provide a fluid channel between a third corner port 140c and lateral flow channels 142. The shunt channels 135 and 137 in FIG. 3A are shown in dashed lines because, in some embodiments, the shunt channels 135, 137 may be formed as open-topped channels in the top surface of the frame layer, while in other embodiments, the shunt channels 135, 137 may be formed as open-topped channels in the bottom surface of the frame layer. First and second lateral flow channels 142a, 142b may be provided adjacent to the respective sub-cell sections 132a, 132b, for example on sides opposite the plenum channel 133. Each of these structures and various alternatives are described in further detail below.

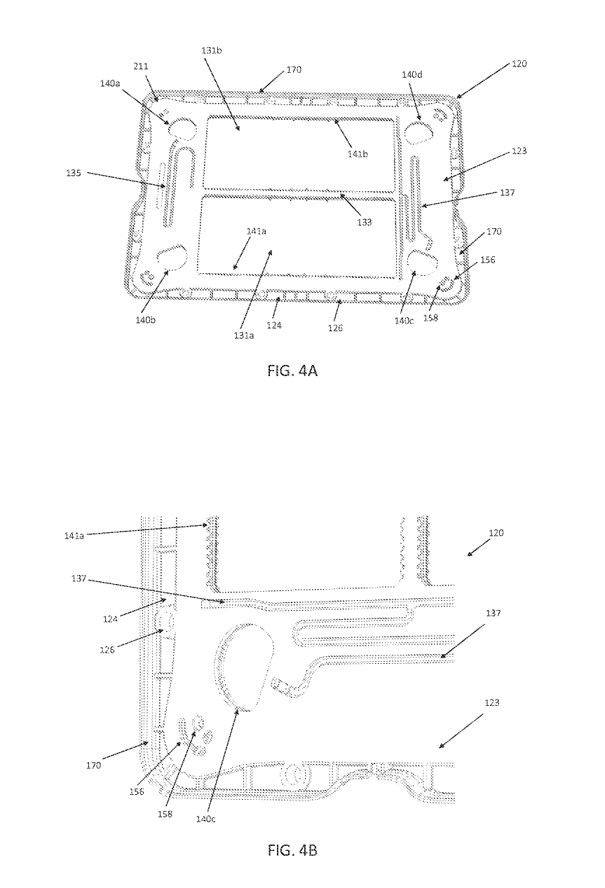

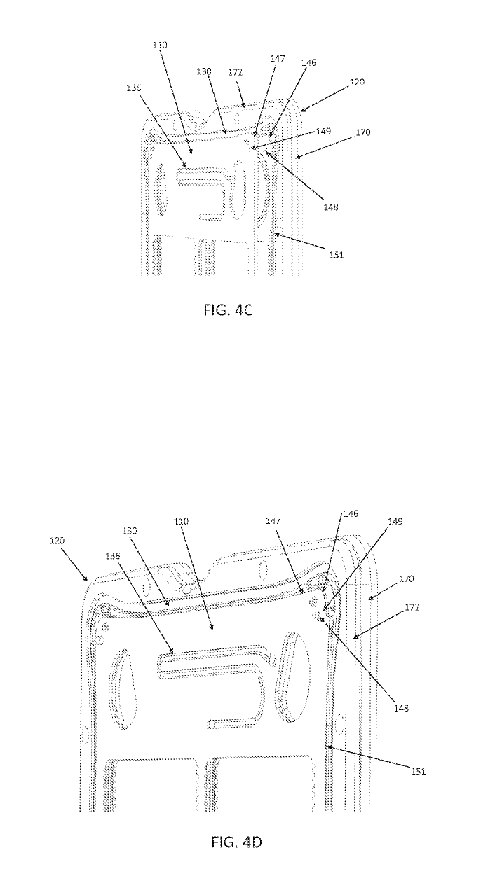

In some embodiments, the shunt channels 135, 137 may be formed as channels in the top surface 122 of a cell frame layer 120, or as channels in the bottom surface 123 of a cell frame layer 120 (e.g., as shown in FIG. 4A).

As shown in FIG. 3A and the close-up view of FIG. 3B, the top surface 122 of the cell frame layer 120 may also be provided with registration structures configured to at least temporarily hold subsequent layers in a proper position and/or alignment on top of the frame layer during assembly, and may provide additional structural integrity and alignment after assembly. For example, the registration structures may include one or more ribs 146 or pins 148, which may extend upwards from one or more parts of a surface of a cell frame layer 120 and, which may mate with corresponding receiving structures.

As shown in FIG. 4A and FIG. 4B, a bottom surface 123 of a cell frame layer 120 may include corresponding registration structure receiving structures, such as a rib recess 156 and a pin recess 158, which may be configured to receive or engage the registration structures, such as the rib 146 and the pin 148 of the top surface 122 of an adjacent cell frame layer 120 that is being joined together. For example, each corner, or other suitable location of a bottom side 123 of a cell frame layer 120 may include the rib recess 156 configured to receive the rib 146 and/or the pin recess 158 configured to receive the pin 148. Such mating or registration structures may assist with maintaining the assembly components in a proper alignment during assembly prior to clamping the stacked assembly together, as described in further detail below. For example, in some cases, electrode felt layers and/or other components may be configured to be compressible such that they occupy a larger volume prior to clamping than after clamping. Accordingly, prior to clamping, components may rest on top of the uncompressed felt layers being supported above a final position and therefore may be prone to shifting before or during clamping. Registration structures, such as the ribs 146 and the pins 148, may be configured to extend above such a raised position to engage and maintain components in a desired alignment relative to one another before and during clamping. Even after clamping, the registration structures may maintain alignment, such as to further prevent lateral movement or shifting of the various layers, which may be caused by mechanical disturbances of the clamped assembly.

FIG. 4C and FIG. 4D provide close-up views illustrating interactions of example registration structures and registration structure receiving features on a cell frame layer 120 and an insert layer 110 positioned on the cell frame layer 120. For example, the insert layer 110 may include a surface 147 configured to engage the inner surface of the rib 146 extending from a cell frame layer 120. The insert layer 110 may further include a hole 149 configured to receive the pin 148 of the cell frame layer 120. In the illustrated example, the cell frame layer 120 may also be configured with a raised edge 151 substantially entirely surrounding a region for receiving an insert layer 110. The insert layer 110 may have a shape configured to conform closely to a shape of the edge 151 surrounding an insert-layer-receiving section of a cell frame layer 120 to provide a conforming fit between the cell frame layer 120 and the insert layer 110. Other registration configurations configured to enforce alignment and/or orientation of stacked structures relative to one another are also possible.

In some embodiments, as shown for example in FIG. 4A, which shows a bottom surface 123 of a cell frame layer 120, the shunt channels 135, 137 may be provided on opposite surfaces, such as the top surface 122 or the bottom surface 123 of the cell frame layer 120. This configuration may allow for gaskets to be positioned on a top surface 122 of the cell frame layer 120 surrounding inlet/outlet ports (e.g., the corner ports 140a-140d) as will be further described herein below. Shunt channels may also be provided in various other shapes and patterns, such as serpentine patterns, swirling patterns, zig-zag patterns, etc.

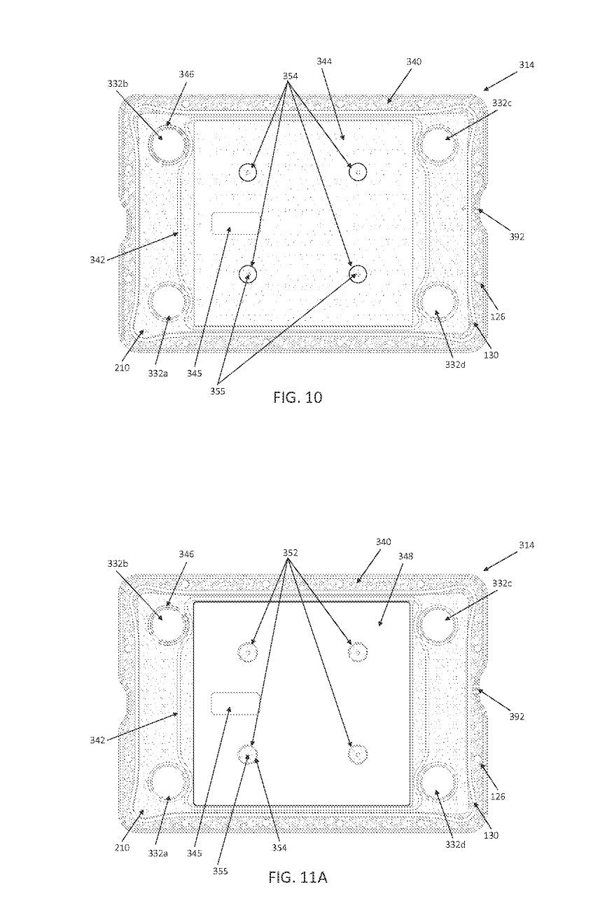

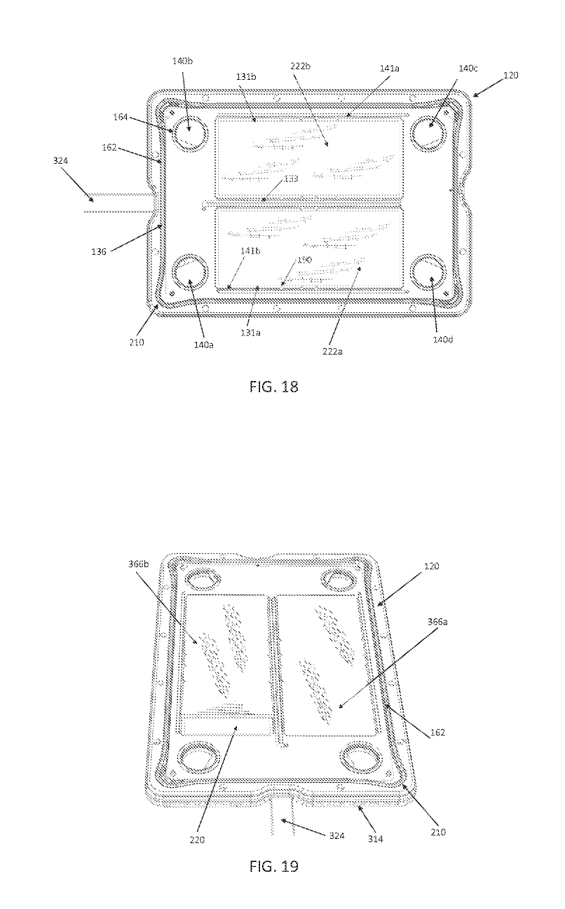

One advantage of the above described nested construction is the provision of multiple sealing surfaces as can be seen in various figures including in FIG. 18. For example, an external sealing channel, such as the gasket channel 130 (See e.g., FIG. 3A, FIG. 3B, FIG. 4D, FIG. 10), may receive a gasket 162 for sealing a cell frame layer 120 against an adjacent cell frame layer 120. Gaskets and O-rings may be made of any suitable material such as rubber, silicone or others.

An O-ring gasket 164 may be provided in an O-ring channel 166 surrounding each in-flow and out-flow port, such as the corner ports 140a, 140b, 140c, 140d. In addition to providing mating surfaces for the O-ring gaskets 164 in the O-ring channels 166, the nested cell layer configuration may also provide substantial flat surfaces with large surface areas relative to liquid flow channels, such as the shunt channels 136, 138, 135 and 137. The flat surfaces may be pressed together when the stack is clamped together. The mating flat surfaces themselves, and the pressure applied to hold the flat surfaces together, may provide further sealing action preventing electrolyte from flowing through areas other than designated flow channels.

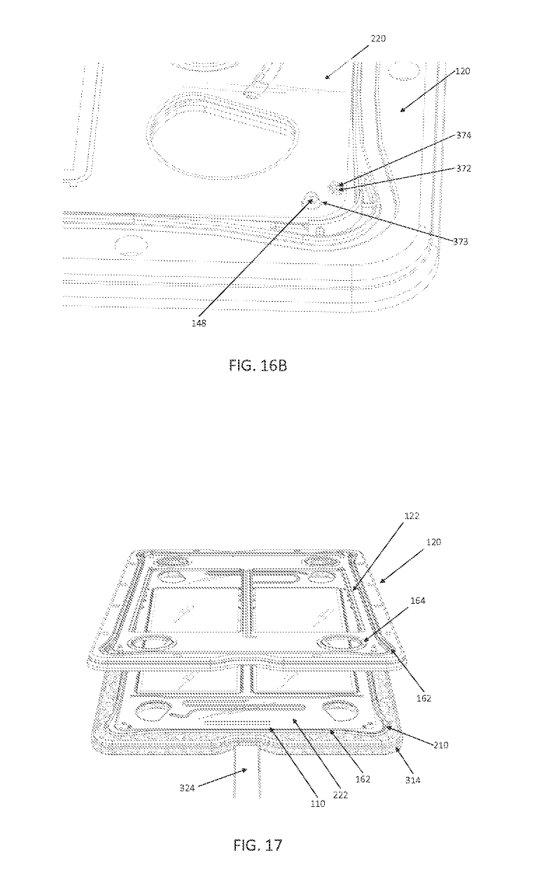

Further, the cell frame layer 120 may be configured with an apron portion 170 configured to surround and engage a corresponding shoulder 172 of an adjacent cell frame layer 120 as shown for example in FIG. 4A-FIG. 4D. Joining of frame layers and the resulting apron-shoulder mating is shown for example, in FIG. 17 and FIG. 25. The apron-shoulder mating surface may be sized and configured to press firmly together, thereby providing an additional external sealing surface and providing additional alignment integrity of the joined layers. In some embodiments, a compressible gasket or a flowable sealing material (not shown) may be provided between the apron portion 170 of one cell frame layer 120 and the shoulder 172 of the next cell frame layer 120 in order to provide a further seal.

### Divided Cell Configuration

In various embodiments, each electrode chamber of a cell in either a frame layer 120 or an insert layer 110 may be divided into two or more sub-sections as shown, for example, in various figures including FIG. 3A which shows a frame layer 120 and FIG. 5 which shows an insert layer 110. For example, the sub-cell sections such as 131a, 131b or 132a, 132b, which may be separated by a plenum channel 133 or 134, may together form an electrochemical half-cell through which a common electrolyte fluid may flow. In some embodiments, electrolyte may flow in the lateral flow channels 141a, 141b or 142a, 142b at lateral sides of the sub-cell sections 132a, 132b of an insert layer 110 or lateral flow channels 141a, 141b at lateral sides of the sub-cell sections 131a, 131b of a cell frame layer 120. Such divided-cell structures may be integrated into cell frame layers 120 as shown in various figures, including, for example in FIG. 3A and FIG. 4A and insert layers 110 as shown in various figures including, for example in FIG. 5 through FIG. 8B.

In some embodiments, electrolyte flow structures such as plenum channels, lateral flow channels, shunt channels may be configured substantially similarly in both frame layers and insert layers. Alternatively, such structures may be configured differently in frame layers than corresponding structures in insert layers. For example, in some embodiments, electrolyte flow structures of an insert layer may be configured to cause a greater resistance to flow relative to flow structures in a frame layer. Such a variation of structure or other parameter may be configured or optimized to counteract a pressure gradient between two flowing liquid electrolytes, such as by increasing flow resistance for an electrolyte that tends to be at a lower pressure under equal flow conditions.

As shown in various examples, each half-cell chamber may be divided into two sub-cell sections. In alternative embodiments, half-cell chambers may be divided into three, four or more sub-cell sections by providing additional plenum structures and/or other flow channels extending through or around a peripheral portion of a half-cell chamber or a sub-cell section.

In some cases, as shown for example in FIG. 3A, FIG. 4A, FIG. 5, and FIG. 6, the plenum channels 133, 134 and lateral flow channels 141a, 141b and 142a, 142b may comprise open-topped channels with the open tops positioned on an opposite side of an insert layer 110 or cell frame layer 120 relative to shunt channels 135, 137, 136, and 138. As will be described by way of examples below, this configuration of plenum channel 133, 134 and lateral flow channels 141a, 141b and 142a, 142b may cause the plenum channels 133, 134 and lateral channels 141a, 141b and 142a, 142b to be sealed against a bipolar plate layer (e.g., as discussed below with reference to FIG. 14) while the shunt channels 135, 137, 136, 138 may seal against a separator layer (e.g., as discussed below with reference to FIG. 16A). Sealing of open-topped plenum and lateral channels against a suitably configured separator layer may prevent interaction of electrolytes across a separator membrane in regions where there is no electrode felt. Similarly, sealing of shunt channels against an electrolyte-impervious bipolar layer may prevent mixing or other interaction between electrolytes of adjacent cells.

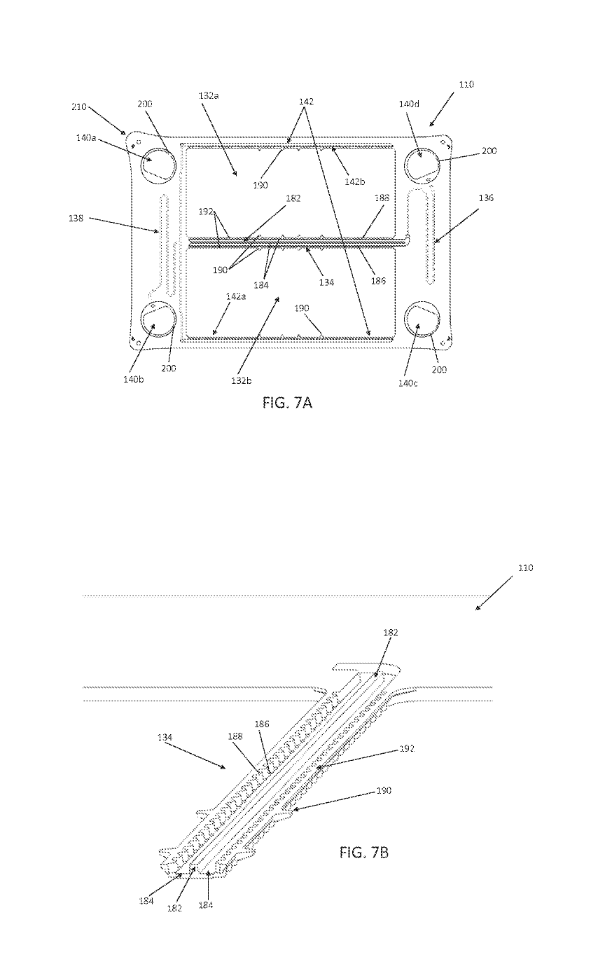

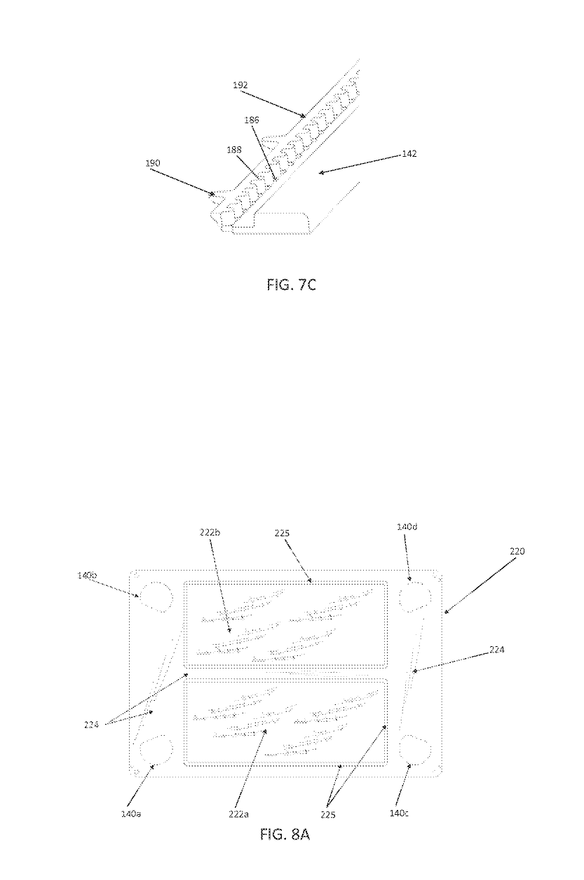

The plenum channels 133, 134 may further include structures for providing mechanical support when multiple cells are stacked together into a cell block. For example, as shown in FIG. 6, FIG. 7A and FIG. 7B, a supporting central rib 182 may be provided between two plenum flow channels 184, each having distribution openings 186 between adjacent ones of columns 188. The plenum channel s 133, 134 may also include flanges 190 or other structures extending from a channel ridge 192 joining the columns 188. Such flanges 190 may extend into an electrode chamber section, such as sub-cell sections 131a, 131b, 132a or 132b and may provide a bearing surface against which similar features of an adjacent one of the plenum channels 133 or 134 of an adjacent insert layer or frame layer may press through a bipolar sheet or other layer. As shown in FIG. 7C, the lateral flow channels 141a, 141b, 142a, 142b may be similarly structured with flanges 190 extending into an electrode section such as the sub-cell section 131a, 131b, 132a, 132b.

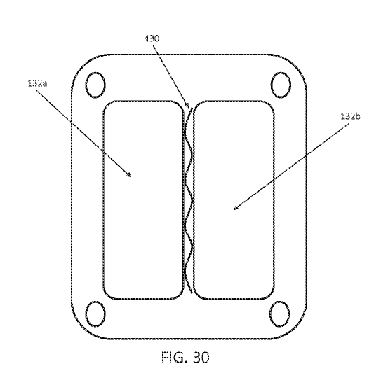

In various embodiments, other plenum support structures may also be provided in order to resist abrasion of bipolar sheets or other materials when stacked cells are compressed. For example, the supporting central rib 182, walls of the plenum channel 133, 134, the flanges 190, or other structures may have other shapes, such as the sinusoidal shape 430 as shown in FIG. 30. Alternatively, various surface textures may be provided to one or more mating surfaces for reducing abrasion risk or controlling how the surfaces interact.

In the arrangement of FIG. 3A and FIG. 4A, which show the flow channels or shunt channels 135, 137 in the cell frame layer 120, in one mode of operation, electrolyte may flow into the frame layer half-cell (which may be a positive or negative half-cell as further described below) through a first port, such as the corner port 140a, through a first serpentine configured one or more of the shunt channels 135 into both sub-cell sections 131a, 131b, into the lateral flow channels 141a, 141b, through a second serpentine configured one or more of the shunt channels 137, and out of the frame layer half-cell through a third corner port 140c. In some cases, flow may be reversed such that electrolyte flows into the second serpentine configured one or more of the shunt channels 137 via the third port 140c, into the electrode chambers, such as sub-cell sections 131a, 131b via the lateral flow channels 141a, 141b, into the plenum channel 133, through the first serpentine configured one or more of the shunt channels 135 and out of the cell via the first port, such as the corner port 140a.

With reference to FIG. 5, FIG. 6 and FIG. 7A, insert layers 110 may be configured with similar electrolyte flow features, in connection with, for example, the second corner port 140b and the fourth corner port 140d, which in various examples, may be inlet or outlet ports. Thus, for example, electrolyte may flow into the half-cell defined by the insert layer 110 through a fourth corner port 140d, through a serpentine configured one or more of the shunt channels 136 into both electrode sections, such as the sub-cell sections 132a, 132b, into the lateral flow channels 142a, 142b, through a second serpentine configured one or more of the shunt channels 138, and out of the half-cell defined by the insert layer 110 through a second corner port 140b. The system may also be configured to flow electrolyte in the opposite direction through the insert layers 110. In such cases, electrolyte may flow through the second corner port 140b, into the second serpentine configured one or more of the shunt channels 138, into the sub-cell sections 132a, 132b via the lateral flow channels 142a, 142b, into the plenum channel 134, through the first serpentine configured one or more of the shunt channels 136 and out through the fourth corner port 140d.

In some cases, electrolytes may be directed through the sub-cell sections 132a, 132b of the insert layer 110 and cell frame layer 120 in the same direction at the same time. Thus, for example, if one electrolyte is flowed through a cell frame layer 120 such that the electrolyte moves from the plenum channel 134 to the lateral channels 142a, 142b, then the second electrolyte may be simultaneously flowed through the insert layer 110 such that the second electrolyte moves from the plenum channel 134 to the lateral channels 142a, 142b. Alternatively, a cross-flow configuration may be used in which a first electrolyte may flow through a cell frame layer 120 in an opposite direction relative to the second electrolyte flowing through the insert layer 110.

As shown in FIG. 6, the insert layer 110 may include recessed sections 200 surrounding inlet/outlet ports, such as the corner ports 140a-140d. The recessed sections 200 of the insert layer 110 may be sized and configured to engage O-rings held by a cell frame layer 120 or a base layer (e.g., 314 in FIG. 25) over which the insert layer sits in a final assembly as will be described in further detail herein below.

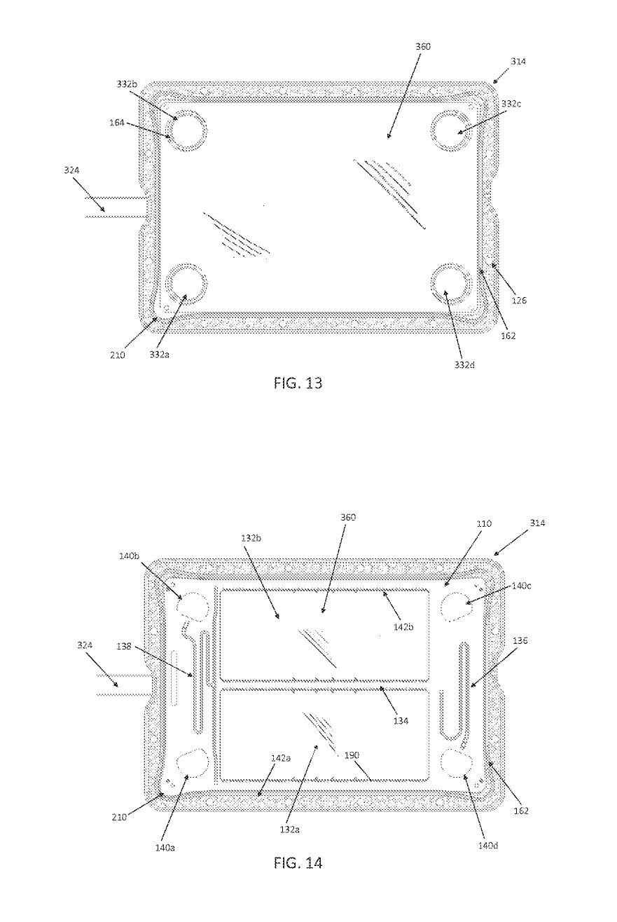

As shown in FIG. 13 and FIG. 14, at ports where fluid is expected to flow into or out of a half-cell (i.e., ports joined to flow or shunt channels 135, 137, 136, 138 in a given layer), recessed sections 200 for receiving an O-ring may be configured such that an O-ring may bear against a surface opposite to a surface in which the flow or shunt channels 136, 138 are formed. As shown in various figures, including FIG. 18, cell frame layers 120 may also be configured with a similar arrangement. FIG. 7A illustrates an alternate configuration in which O-ring recessed sections are on the same side as the shunt channels 136, 138.

In some cases, flow structures may be provided in the insert layer 110 in a substantially identical pattern to those in the cell frame layer 120. By placing the insert layer 110 into the cell frame layer 120 such that the flow structures are rotated 180 degrees relative the structures in the cell frame layer 120, the electrolytes may flow into and out of the insert-layer sections such as the sub-cell sections 132a, 132b via the two ports that are not joined to the flow or shunt channels 135, 137 of the cell frame layer 120. Thus, the insert layer 110 and the cell frame layer 120 may provide chambers for the opposite (positive and negative) electrolytes while preventing mixing or other interaction of the electrolytes. Configuring insert layers and frame layers with identical flow structures provides the advantage that each electrolyte flow stream will experience the same flow resistance as electrolytes are pumped through a complete stack.

In some embodiments the cell frame layer 120 and the insert layer 110 may include mating structures configured to cause the insert layer 110 to only fit in the frame layer in a desired orientation. Thus, for example, one corner of a cell frame layer 120 may include an enlarged recess 211 (e.g., see FIG. 3A) configured to receive an enlarged tab 210 (e.g., see FIG. 5 and FIG. 21) extending from a corresponding corner of an insert layer 110. Similarly, the cell frame layer 120 and/or the insert layer 110 may comprise structures forcing the insert layer 110 to fit with a desired face mating with the cell frame layer 120. As can be seen in FIG. 4C and FIG. 4D, such structures may include pins 148 protruding from a mating surface of the cell frame layer 120. Such pins 148 may be received within recesses or holes 149 in an insert layer 110.

In some embodiments, a separator membrane may be positioned between a cell frame layer 120 and an insert layer 110 nested within the cell frame layer 120 with a first current collector layer below the cell frame layer 120 and a second current collector layer above the cell frame layer 120. In such embodiments, a complete cell may be formed by a cell frame layer 120 and an insert layer nested therein.

Alternatively, a current collector plate may be positioned between a cell frame layer 120 and an insert layer 110 nested within the same cell frame layer 120, and a separator layer may be positioned between an insert layer 110 and a concave region of an adjacent cell frame layer 120. In such embodiments, a complete cell may be formed by an insert layer and an adjacent frame layer.

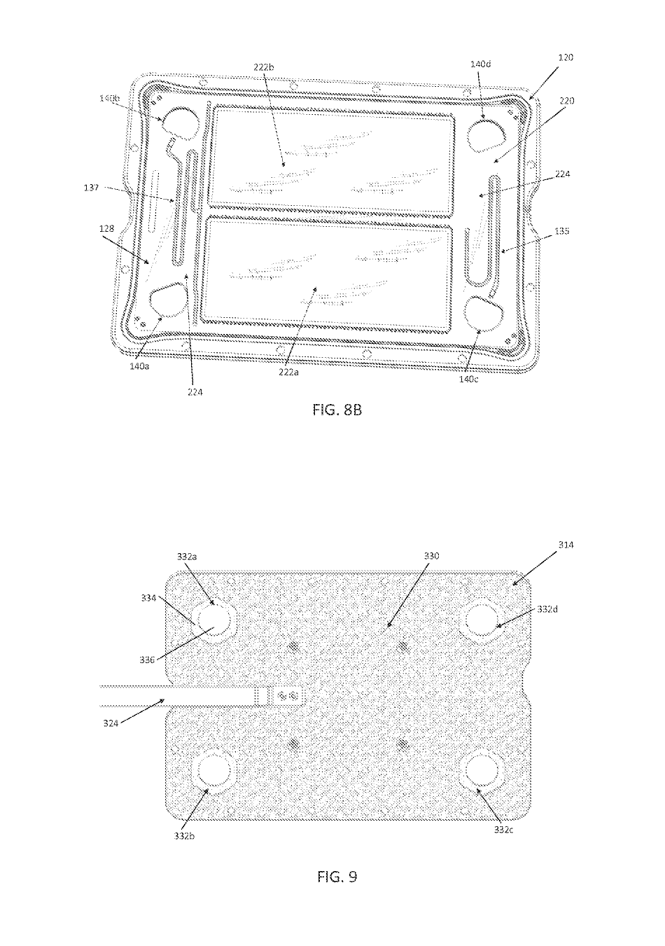

As shown in FIG. 8A and FIG. 8B, in some embodiments, a separator layer 220 may be configured as a composite structure including active sections, active areas, or active regions 222a, 222b made of a porous or ion-selective separator material joined to impermeable sections or inactive regions 224 made of a material selected to seal inactive regions of one half-cell from inactive regions of an adjacent half-cell. The impermeable material covering the inactive regions 224 may be any suitable non-reactive and non-conductive, electrolyte-impermeable material such as polyethelyne, LDPE (low density polyethylene), polypropylene, or other plastics. As shown in FIG. 8B, inactive regions 224 of the cell may include substantially all areas between extents of a recessed section 128 of a frame layer 120 (or of an insert layer 110 sized to fit within the recessed section 128) other than the regions overlaying the electrode chambers, such as the sub-cell sections 132a, 132b and inlet/outlet port regions 140a-140d.

In some embodiments, active regions 222a, 222b may be permeable or semi-permeable and may be joined to impermeable inactive regions 224 by any suitable sealing or bonding method. For example, the sections may be heat sealed by applying heat and pressure to a region at which a portion of the permeable or semi-permeable separator material overlaps a portion of the impermeable material, thereby forming seams 225 surrounding the perimeter of the active regions 222a, 222b. Alternatively, the sections may be ultrasonically welded by overlapping a portion of the permeable or semi-permeable material with a portion of the impermeable material and treating the overlapping region with high frequency ultrasound energy with or without pressure applied to the overlapping regions. Alternatively, the sections may be bonded with adhesives or solvents by applying an adhesive or solvent to a portion of one or both of the permeable or semi-permeable material and the impermeable material and pressing the materials together. Alternatively any combination of such methods or any other sealing or bonding methods may be used.

### Stack Assembly

With reference to FIG. 9 through FIG. 25, examples of a complete stack assembly will be described. FIG. 25 shows an example of a complete instance of a stack assembly 300 containing two complete cells in a clamped configuration. In addition to the two frame layers 301, 302 visible in FIG. 25, the stack assembly 300 may be configured with an upper structural end plate 310 and a lower structural end plate 312, an upper base plate 380 and a lower base plate 314, a plurality of clamping bolts 318, four inlet/outlet pipe connectors 320 and two electrical connection leads 322, 324.

FIG. 9 shows a first side 330, such as a bottom side, of a lower base plate 314 with an electrical connection lead 324. The base plate 314 may include four main inlet/outlet ports 332a, 332b, 332c, 332d, each of which may have a non-circular (e.g., hexagonal or other polygonal) recess 334 configured to receive and secure connectors that may be joined to pipe sections that may extend through circular holes 336 to be joined to fluid conduits for carrying electrolytes to or from the stack.

FIG. 10 shows a second side 340, such as a top side, of base plate 314. In some cases, the base plate 314 may be made of a rigid non-reactive material such as high density polyethylene. In some embodiments, the base plate 314 may include an inner gasket channel 342 surrounding a central recessed area 344. A rubber gasket within the inner gasket channel 342 may be used to seal electrolytes from entering the central recessed area 344, which may contain a metallic electrically conductive plate and a structural metallic end plate. The O-ring gaskets 164 (e.g., FIG. 13) may also be provided in O-ring channels 346 surrounding each inlet/outlet port 332a-332d. A base plate 314 may also include an outer channel, such as the gasket channel 130 in the same position as a corresponding outer channel, such as the gasket channel 130 in a cell frame layer 120. The base plate 314 may also include a plurality of registration pins 354 which may include center holes 355 for aligning joined structures.

In some cases, to provide further structural rigidity, the central recessed area 344 of the base plate 314 may be configured to receive a rigid element such as a structural metallic plate 348 as shown in FIG. 11A. In some cases, the structural metallic plate 348 may be aluminum, titanium or other minimally reactive, relatively light weight, but highly rigid material. The structural metallic plate 348 may comprise holes 352 configured to receive registration pins 354 extending therethrough. The structural metallic plate 348 may also include a cutout 345 through which an electrical connection lead may extend.

FIG. 11B illustrates an alternate base plate configuration in which the structural metallic plate 348 of FIG. 10 is omitted. In such an embodiment, center holes 355 may be formed directly in a solid section 343 of material from which the base plate is formed. In some embodiments, the entire base plate, including the solid center section 343 may be made of a material such as high density polyethylene or chlorinated polyvinyl chloride.

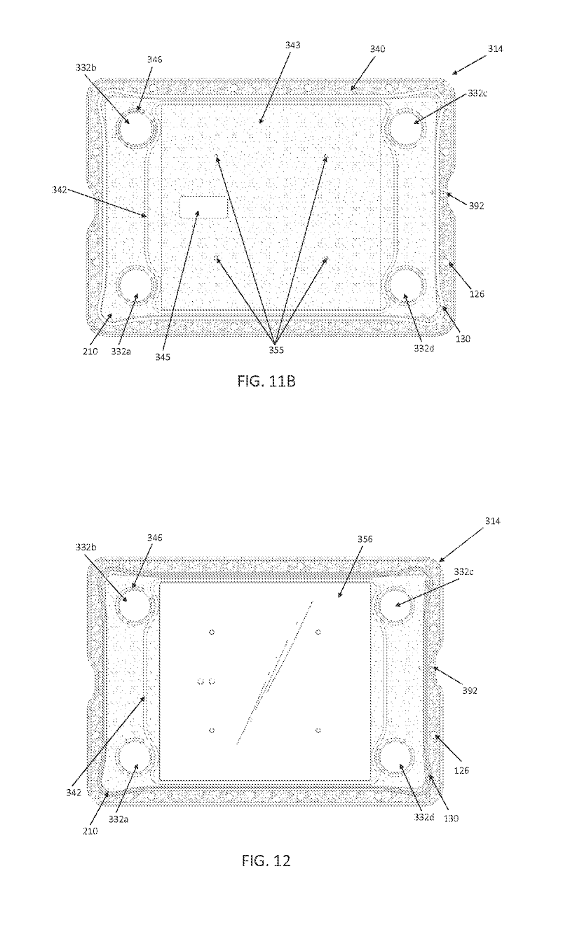

As shown in FIG. 12, an electrically conductive end plate 356 may be positioned over the structural metallic plate 348. The electrically conductive end plate 356 may include pins configured to align with the center holes 355 in the registration pins 354 of the base plate 314 extending through the structural metallic plate 348 of FIG. 11A. The electrically conductive end plate 356 may also include screws, bolts or other connectors configured to extend through the cutout 345 in the structural metallic plate 348 and the base plate 314. The connectors may be mechanically and electrically joined to an electrical lead extending through the cutouts. The electrically conductive end plate 356 may be made of any suitable electrically conductive material such as copper.

In some embodiments, a bipolar plate layer 360 of a non-reactive electrically conductive material may be placed over the electrically conductive end plate 356 in the base plate 314 as shown for example in FIG. 13. In some cases, the non-reactive electrically conductive material for the bipolar plate layer 360 may be a graphite based polymer composite material that is flexible, strong, electrically conductive, non-porous and non-reactive to electrolyte acids. One example of such a material may be SIGRACET® TF6 made by SGL Group. Other carbon or graphite materials may also be used. One advantage of a composite material, such as SIGRACET® TF6, is that it may be substantially impermeable to electrolyte, thereby preventing electrolyte from contacting and reacting with the electrically conductive end plate 356, such as when the plate is metallic, while still conducting electrical current. In the present example, the bipolar plate layer 360, of non-reactive electrically conductive material may form a monopolar end plate that may contact an electrode felt of the first electrochemical cell. Although some layers of the non-reactive electrically conductive material associated with the bipolar plate layer 360 may act as monopolar elements, the term “bipolar plate layer” may be used herein to refer to non-reactive electrically conductive material layers in any position within a stack.

As shown in FIG. 14, an insert layer 110 may be positioned over top of the bipolar plate layer 360. The insert layer 110 may form a positive half-cell chamber (which may be made up of multiple sub-cell sections, or may comprise a single chamber section) and positive electrolyte flow channels for a first cell of the stack. In alternative embodiments, the base plate 314 may be configured to omit the first insert layer such that a first half-cell structure may be formed by a first frame layer. Also, while the first insert layer 110 forms a first positive half-cell in the present example, the first insert layer 110 may alternatively be used as a negative half-cell. One advantage for positioning a positive half-cell below a negative half-cell is to address a hydrogen generation side-reaction, which may tend to occur in a negative half-cell. If the negative half-cell is oriented above the positive half-cell, hydrogen bubbles will be arrested by the bipolar plate adjacent the negative electrode, and will be directed to an outlet port to be carried out of the stack. If the negative half-cell were below the positive half-cell, hydrogen bubbles may collect on the surface of the separator, potentially reducing the area at which reactions may occur. In further alternative embodiments, a stack may be positioned on one side in a final assembly such that both the positive and negative half-cells are oriented in a vertical plane.

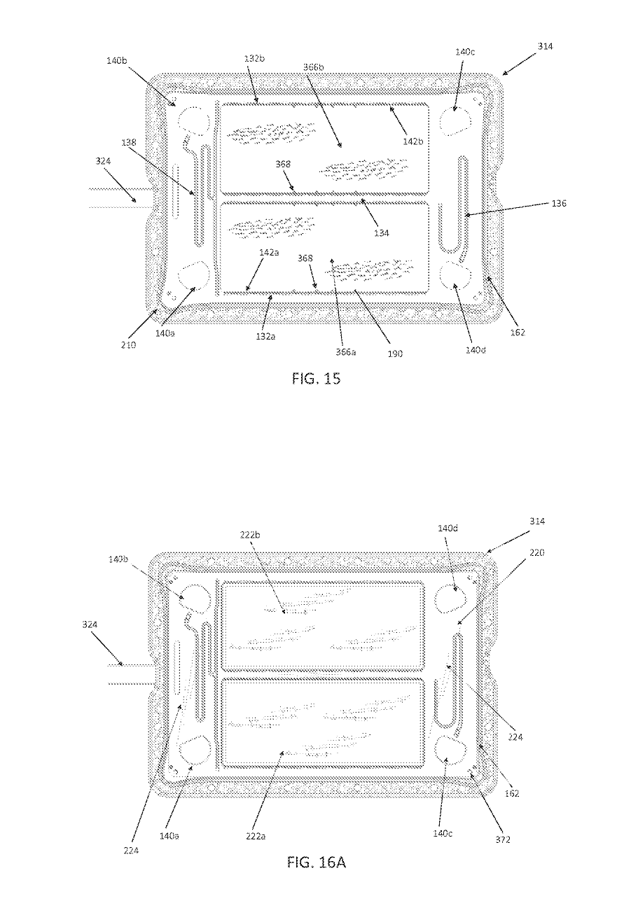

As shown in FIG. 15, electrode felt sections 366a, 366b may be positioned in the sub-cell sections 132a, 132b. In some embodiments, the electrode felt sections 366a, 366b may include notches 368 cut to surround flanges 190 extending from the plenum channel 134 and the lateral flow channels 142a, 142b. Such corresponding structures may prevent the felt from shifting within the half-cell chamber or sub-cell section once the final assembly is clamped together.

In some embodiments, the electrode felt sections 366a, 366b may be sized to be thicker in an un-compressed state than a maximum thickness of the insert layer 110, allowing the felt sections to be compressed when the final stack assembly is clamped together. Using material that is thicker when uncompressed, and compressing the material during clamping may advantageously increase the electrical conductivity of the felt sections due to the bulk increase in the amount of material used. Similarly, the O-ring gaskets 164 and gaskets 162 may be sized so as to have a thickness that extends beyond a surface of an insert layer 110 or cell frame layer 120. The O-ring gaskets 164 and the gaskets 162 may also be made of materials selected to compress or deform slightly when a final assembly is clamped together to improve the sealing action. The electrode felt sections 366a, 366b may generally be made of a non-reactive electrically conductive material through which a liquid electrolyte may flow, even when compressed. For example, carbon or graphite felt may be cut or stamped to a desired shape.

As shown in FIG. 16A, the separator layer 220 may then be placed on top of the insert layer 110. In some embodiments, the separator layer 220 may include holes 372 that may engage hooks 374 at corners of the insert layer 110. The separator layer 220 may also include holes 373 sized and positioned to receive the pins 148 extending from a cell frame layer 120. Examples of such features may be seen in the close-up view of FIG. 16B.

In some embodiments, the separator layer 220 may be configured as a continuous layer of an ion-selective membrane or a microporous membrane. In other embodiments, as shown in FIG. 16A, a separator layer 220 may be configured as a composite construction including active regions 222a, 222b made of an ion-selective or microporous membrane surrounded by inactive regions 224 made of a substantially electrolyte-impermeable material. In various embodiments, the active regions 222a, 222b may be sealed to the inactive regions 224 by any suitable process including heat sealing, sonic welding, solvent, sealing, for example as described herein above. Alternatively, the active regions 222a, 222b may be configured as separate structures that are not sealed to the inactive regions, but may be held in place by mechanical forces. One advantage to a composite structure in which inactive regions are impermeable to ion transfer is that electrochemical reactions and any ion or liquid cross-over will be limited to desired regions of the structure, rather than allowing reactions to occur across intersections of positive and negative electrolyte flow channels, such as shunt channels 136, 138, plenum channels 134 or lateral flow channels 142a, 142b.

Whether configured as a continuous permeable or semi-permeable material or a composite construction, the separator layer 220 may include cutout regions at the inlet/outlet ports, such as the corner ports 140a-140d. The cutouts may have a size and shape that substantially matches the inlet/outlet ports such that, when compressed, the separator layer seals against flat surfaces of an insert layer 110 and an adjacent cell frame layer 120.

As shown in FIG. 17, with a separator layer 220 in place, a cell frame layer 120 may be placed over the base plate 314 and the insert layer 110. A bottom surface of the cell frame layer 120 may seal against the outer gasket 162 in the base plate 314. The O-ring gaskets 164 may be provided in the O-ring channels 166 surrounding the inlet and outlet ports, such as the corner ports 140a-140d of the cell frame layer 120. An outer gasket 162 may also be positioned in a gasket channel 130 surrounding the recessed region 122 of the insert layer 110.

As shown in FIG. 19, electrode felt sections 366a, 366b may be positioned in the sub-cell sections 132a, 132b between the plenum channel 134 and the lateral flow channels 142a, 142b of the cell frame layer 120. In this example, the half-cell formed by the cell frame layer 120 may be the negative half-cell of the first complete cell of this example stack.

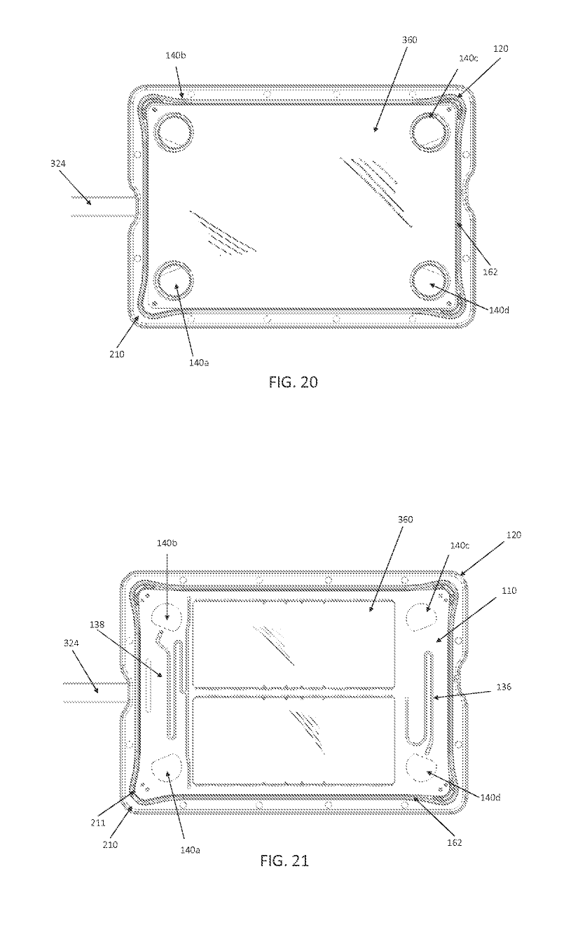

As shown in FIG. 20, a bipolar plate layer 360 may then be placed into the recessed region 122 (visible in other figures, including FIG. 17) of the cell frame layer 120, thereby completing the first cell. In some embodiments, the bipolar plate layer 360 may be made of the same material as the non-reactive electrically conductive material of the bipolar plate layer 360 described above with reference to FIG. 13. Such a material for the bipolar plate layer 360 may provide both a fluid-sealing function, which prevents electrolyte from leaking between the first cell and the second cell, while also conducting electrical current between the first cell and the second cell. As shown in FIG. 20, the bipolar plate layer 360 may include cutouts at the inlet/outlet ports, such as the corner ports 140a-140d. In some embodiments, the cutouts may be large enough to allow the O-rings to extend therethrough, thereby allowing the O-rings to seal against a bottom surface of the next insert layer as shown in FIG. 22. In other embodiments, the cutouts may be sized such that O-rings may seal against the bipolar plate layer 360.

FIG. 21 shows an insert layer 110 placed over the bipolar plate layer 360. The insert layer 110 of FIG. 21 may form the positive half-cell of the second cell of this example stack. The second cell may be completed by repeating the steps described above of placing positive ones of the electrode felt sections 366a, 366b into the sub-cell sections 132a, 132b, placing a separator layer 220 on the insert layer 110, placing a second cell frame layer 120 and negative electrode felts over the separator layer, and finally placing a bipolar (or monopolar) plate over the frame layer.

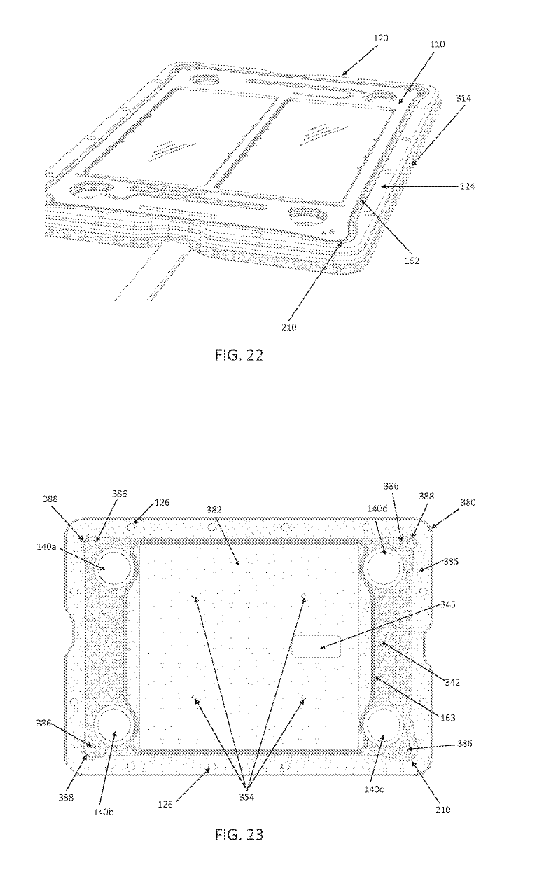

Once a desired number of cells has been assembled, a top base plate 380 may be placed over the final cell frame layer 120. FIG. 23 shows an example of a top base plate 380 that includes some features similar to features described above with reference to a base plate 314 and some unique features. Similarly to the base plate 314, the top base plate 380 may include a recess 382 for receiving structural metallic plate 348 and electrically conductive end plate 356 (e.g., metal plates), a cutout 345 for receiving an electrical contact, and an inner gasket channel 342 in which an inner gasket 163 may be placed to seal the metal plates away from the electrolyte regions. Alternatively, the top base plate 380 may include a solid section of material in place of the metallic plate as described above with reference to FIG. 11B. Uniquely, the top base plate 380 may include a peripheral recess 385 sized and configured to receive a corresponding peripheral surface or structure such as the border section 124 of the final cell frame layer 120. The top base plate 380 may also include registration features such as pin recesses 386 and/or rib recesses 388 for receiving corresponding structures of a cell frame layer 120.

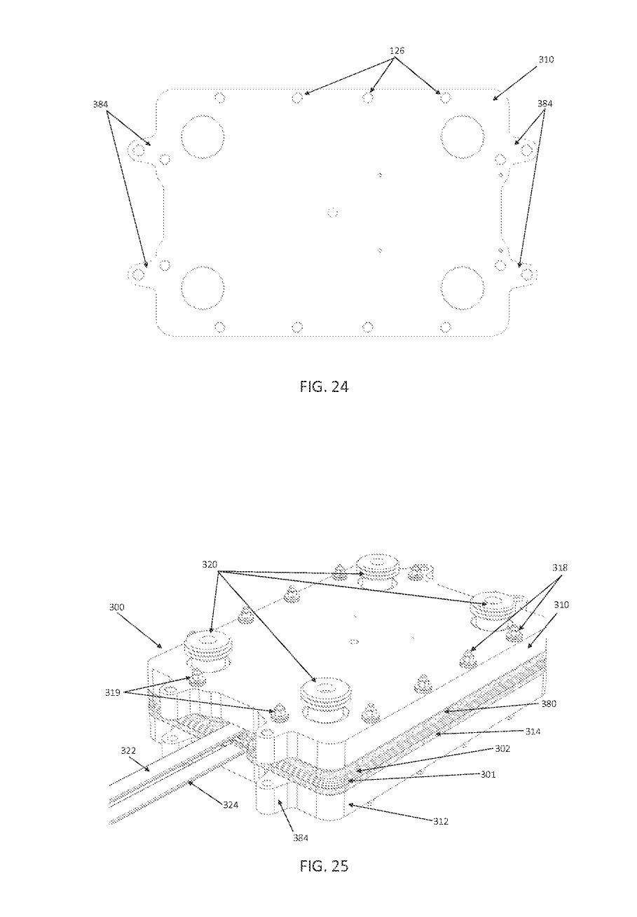

When configuration of the components and assembly of the stack is completed, the stack may be sandwiched between top and bottom clamping plates, such as the upper structural end plate 310, and the lower structural end plate 312. FIG. 24 illustrates an example clamping plate, such as the upper structural end plate 310 that includes a plurality of bolt holes 126 configured to align with bolt holes extending through corresponding bolt holes 126 in cell frame layers 120 and base plates 314, 380. As shown in FIG. 25, the stack assembly may be clamped together by passing the clamping bolts 318 through the bolt holes 126 and tightening nuts 319 to apply a suitable pressure to the stack components. The clamping plates, such as the upper structural end plate 310, and the lower structural end plate 312 may also include flanges 384 with through-holes that may be used for mounting the stack assembly to a superstructure and/or to provide further clamping force.

In some cases, an assembly of a group of cells between a top base plate 380 and a base plate 314 may be referred to herein as a “cell block.” A cell block may be defined as a group of electrochemical cells in a common bipolar stack configured to operate as a common unit. In some cases, two or more cell blocks may be provided between a single pair of clamping plates such as the upper structural end plate 310, and the lower structural end plate 312. When two or more cell blocks are provided between a single pair of clamping plates, such as the upper structural end plate 310, and the lower structural end plate 312, the cell blocks may each be electrically isolated from adjacent cell blocks, thereby allowing for convenient mechanical assembly while allowing for variability in electrical connection configurations.

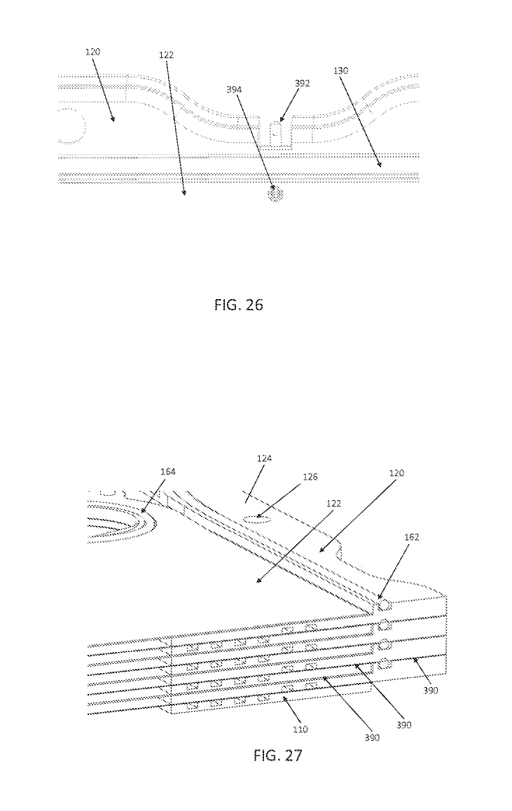

As shown in the close-up view of FIG. 26, each cell frame layer 120 may also include a voltage test tab 392 with one end extending to a blind hole 394 in the top surface of the cell frame layer 120. An electrically conductive disc (not shown) may be placed over the portion of metal exposed by the blind hole to protect the metallic tab from corrosive electrolytes. Such a disc may be made of a material such as a carbon black paste, or a material similar to that used for the bipolar plates, such as a non-reactive, non-permeable electrically conductive composite. The disc may be sized so as to contact the bipolar plate layer 360 lying between the cell frame layer 120 and an insert layer 110 nested therein. The voltage test tabs may be used to monitor and evaluate electrical performance of individual cells in a stack or block.

Nested Frame Layers with Inner and Outer Seals

One consideration in flow through cells and cell blocks is the hydraulic pressures needed to pump electrolytes through the chambers of multiple cells in a bipolar stack. In some cases, significantly high pressures may be required. In such cases, seals for preventing electrolytes from leaking out of a cell or out of a cell block may be needed. On one hand, it may be desirable to seal each cell chamber from adjacent sub-cell sections in order to reduce cross-cell leakage which may reduce operating efficiency of a flow battery. In addition, it may also be desirable to seal an entire stack to prevent electrolytes from leaking out of the stack and causing external damage or contamination.

Configuration of seals in a flow battery stack may involve balancing many competing factors, including minimizing cross-cell leaks, minimizing pressure drop, minimizing weight, minimizing material costs, maximizing safety, etc. In some flow battery arrangements, a certain degree of cross-mixing of positive and negative electrolytes may be acceptable. Thus, in some cases it may be possible to de-couple some stack configuration objectives, such as decreasing the risk of external leaks and minimizing pressure drop and material cost. Some flow battery configurations using structures and configurations described herein may deal separately with these two sealing needs.

For example, as can be seen in FIG. 27 (among others herein), the nested stack configuration described above may provide a space for a gasket surrounding each frame layer to seal against leakage to the outside of the stack. Structures between adjacent frame layers may be configured with additional internal seals in the form of gaskets 162, O-ring gaskets 164 and mating flat surfaces 390 that may be pressed together under a clamping force.

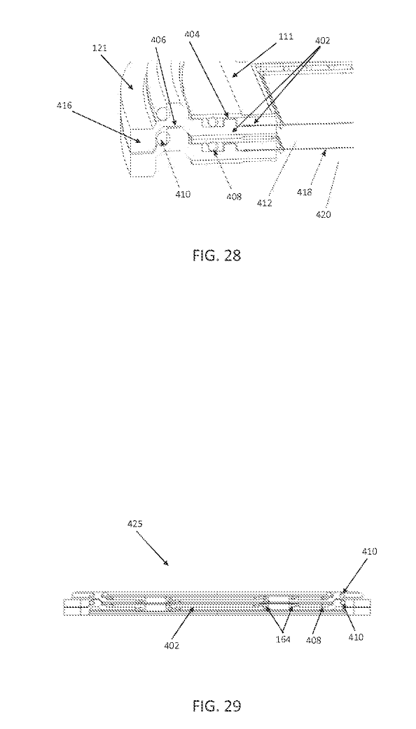

FIG. 28 and FIG. 29 illustrate an alternative stack configuration incorporating similar features and advantages to those described above. In some embodiments, an inner seal and/or an outer seal may include one or more tightly-fitting surfaces with a substantial surface area. For example FIG. 28 illustrates examples of mating surface seals, such as flat surface seals 402 and both inner stepped-surface seals 404, and outer stepped-surface seals 406. As described with reference to some examples above, flat surface seals 402 may comprise opposing flat surfaces of adjacent assembly layers. The adjacent layers may be mechanically compressed sufficiently that a minimal but acceptable volume of liquid may leak into the area between the layers along the flat surface seal 402 under expected operating pressures. Similarly, the inner stepped-surface seals 404, and the outer stepped-surface seals 406 may create a longer path of opposing surfaces, thereby further resisting fluid leakage. Compressible gaskets 408, 410 may be placed at outer regions adjacent the surface seals 402, which may provide a further seal.

A main inner seal, such as the compressible gasket 408, may surround each positive cell chamber 412 and may provide a seal substantially preventing electrolyte from leaking out of a cell chamber 412 into adjacent cell chambers 420. The inner seal, such as the compressible gasket 408 may be configured to withstand a relatively low pressure, which may be substantially close to an operating pressure of a flow battery stack. In some examples, operating pressures may be about 10 psi to about 50 psi. In some embodiments, such as shown in FIG. 28, a compressible gasket material may be provided for each of the inner seal and the outer seal, such as the compressible gaskets 408, 410.

An outer seal 416 may be provided to surround substantially all of the cell components, and may be configured to withstand a substantially higher pressure, thereby providing a high margin of safety against electrolyte leaking from the stack assembly. The outer seal 416 may include a compressible gasket 410 sandwiched and compressed into a seal channel.

FIG. 29 provides a cross-sectional view of a single cell 425, through a region including inlet/outlet ports. In some embodiments, the inlet/outlet ports may include the O-ring gaskets 164 to seal the ports against leakage from one cell chamber to another.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Various modifications to the above embodiments will be readily apparent to those skilled in the art, and the generic principles defined herein may be applied to other embodiments without departing from the spirit or scope of the invention. For example, any of the individual components described above, or some combinations of the components may be considered non-essential to a complete electrochemical flow cell stack. Any of the components may be modified or omitted as may be suitable for a particular embodiment application. Thus, it is intended that the scope of the present invention herein disclosed should not be limited by the particular disclosed embodiments described above, but should be determined only by a fair reading of the claims that follow.

In particular, materials and manufacturing techniques may be employed as within the level of those with skill in the relevant art. Furthermore, reference to a singular item, includes the possibility that there are plural of the same items present. More specifically, as used herein and in the appended claims, the singular forms “a,” “and,” “said,” and “the” include plural referents unless the context clearly dictates otherwise. As used herein, unless explicitly stated otherwise, the term “or” is inclusive of all presented alternatives, and means essentially the same as the phrase “and/or.” It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

1. An electrochemical flow cell stack, comprising:
a plurality of frame layers, each of the plurality of frame layers having a peripheral gasket channel configured to receive a gasket material therein, the gasket channel surrounding a recessed area having a size and a structure configured to receive an insert layer, each of the plurality of frame layers comprising at least one void area defining a first half-cell chamber of a flow cell;
a plurality of insert layers, each of the plurality of insert layers nested within a corresponding one of the plurality of frame layers, each of the plurality of insert layers comprising at least one void area defining a second half-cell chamber of the flow cell formed by one of the plurality of frame layers and one of the plurality of insert layers.

2. The electrochemical flow cell stack of claim 1, wherein each of the plurality of frame layers further comprises a plurality of openings defining inlet/outlet ports and at least a first channel defining a first flow path joining a first one of the plurality of openings defining the inlet/outlet ports to the first half-cell chamber and at least a second channel defining a second flow path joining the first half-cell chamber to a second one of the plurality of openings defining the inlet/outlet ports.

3. The electrochemical flow cell stack of claim 2, wherein each of the plurality of insert layer further comprises a third channel defining a third flow path joining a third one of the plurality of openings defining the inlet/outlet ports to the second half-cell chamber and a fourth channel defining a fourth flow path joining the second half-cell chamber to a fourth one of the plurality of openings defining the inlet/outlet ports.

4. The electrochemical flow cell stack of claim 3, wherein each of the plurality of insert layers and each of the recessed areas of the plurality of frame layers are configured with a size and a shape such that each of the plurality of insert layers nests within corresponding ones of the plurality of frame layers in a single orientation.

5. The electrochemical flow cell stack of claim 3, wherein each of the plurality of frame layers further comprises one or more flat surfaces surrounding the first channel, the one or more flat surfaces configured to seal against one or more adjacent structures in the electrochemical stack.

6. The electrochemical flow cell stack of claim 5, wherein the one or more adjacent structures comprise one or more separator layers.

7. The electrochemical flow cell stack of claim 5, wherein the one or more adjacent structures comprise one or more bipolar plate layers.

8. The electrochemical flow cell stack of claim 1, further comprising a pair of structural base plates and a pair of structural clamping plates configured to secure the plurality of frame layers and the plurality of insert layers.

9. The electrochemical flow cell stack of claim 8, further comprising a pair of sealing monopolar plate layers adjacent to the pair of structural base plates.

10. The electrochemical flow cell stack of claim 9, wherein the pair of sealing monopolar plate layers are constructed from a non-reactive electrically conductive material that is impermeable to an electrolyte.

11. The electrochemical flow cell stack of claim 1, further comprising a first porous electrode positioned in the first chamber of each of the plurality of frame layers and a second porous electrode positioned in the second half-cell chamber of each of the plurality of insert layers.

12. The electrochemical flow cell stack of claim 11, wherein the first porous electrode has a thickness greater than a thickness of one of the plurality of frame layers.

13. The electrochemical flow cell stack of claim 12, wherein each of the plurality of frame layers and each of the plurality of insert layers further comprise at least one registration feature configured to align each of the plurality of insert layers relative to each of the plurality of frame layers.

14. The electrochemical flow cell stack of claim 11, wherein the first porous electrode is compressible such that a thickness of first porous electrode is reduced by compression when each of the plurality of frame layers and each of the plurality of insert layers are compressibly joined into a clamped configuration.

15. The electrochemical flow cell stack of claim 1, further comprising a first electrode section positioned in the first half-cell chamber of each of the plurality of frame layers and a second electrode section positioned in the second half-cell chamber of each of the plurality of insert layers.

16. The electrochemical flow cell stack of claim 15, further comprising a separator layer positioned between the first half-cell chamber of each of the plurality of frame layers and the second half-cell chamber of each of the plurality of insert layers.

17. The electrochemical flow cell stack of claim 16, wherein an area dimension of the first electrode section and the second electrode section are configured to be substantially the same as an area dimension of an active area section of the separator layer.

18. The electrochemical flow cell stack of claim 1, wherein the first half-cell chamber of each of the plurality of frame layers is divided into a first sub-cell section and a second sub-cell section by a plenum channel, and the first sub-cell section comprises a first porous electrode section and the second sub-cell section comprises a second porous electrode section.

19. The electrochemical flow cell stack of claim 18, wherein each of the plurality of frame layers further comprises a first lateral channel adjacent to the first sub-cell section and a second lateral channel adjacent to the second sub-cell section.

20. The electrochemical flow cell stack of claim 18, wherein the plenum channel comprises at least one flange extending into at least one of the first sub-cell section and the second sub-cell section.

21. The electrochemical flow cell stack of claim 19, wherein at least one of the first lateral channel and the second lateral channel comprises a flange extending into a respective at least one of the first sub-cell section and the second sub-cell section.

22. The electrochemical flow cell stack of claim 18, further comprising a separator layer having one or more active areas made of a semi-permeable membrane material and one or more inactive areas made of an impermeable material, wherein the one or more active areas are configured to align with the first and second sub-cell sections.

23. The electrochemical flow cell stack of claim 22, wherein the semi-permeable membrane material of the one or more active areas are bonded to the impermeable material of the one or more inactive areas by heat sealing.

24. The electrochemical flow cell stack of claim 22, wherein a dimension of the first porous electrode section and the second porous electrode section have substantially the same dimensions as the one or more active areas made of the semi-permeable membrane material.

25. The electrochemical flow cell stack of claim 8, wherein the plenum channel further comprises a central support rib.

26. The electrochemical flow cell stack of claim 1, wherein each of the plurality of frame layers includes a voltage test tab configured to provide an electrical connection to the first half-cell chamber.

27-38. (canceled)

39. An electrochemical flow cell stack, comprising:
a first structural end plate;
a first base layer positioned adjacent to and in contact with the first structural end plate, the first base layer comprising an outer peripheral gasket channel configured to receive a gasket material therein, the gasket channel surrounding a recessed area having a size and a structure configured to receive an insert layer;
a first frame layer positioned adjacent to and in contact with at least portions of the first base layer and the first insert layer, the first frame layer having an outer peripheral gasket channel configured to receive a gasket material therein, the gasket channel surrounding a recessed area having a size and a structure configured to receive an insert layer, the frame layer comprising at least one void area defining at least a portion of a first half-cell chamber of the first flow cell;
a first insert layer nested within the recessed area of the first frame layer, the first insert layer comprising at least one void area defining at least a portion of a second half-cell chamber of the first flow cell, the first insert layer further comprising a plenum channel dividing the first half-cell chamber into two sub-cell sections;
a first separator layer sandwiched between the first insert layer and the first frame layer and having at least one semi-permeable active area section configured to separate the first half-cell chamber from the second half-cell chamber, the first separator layer further comprising impermeable sections sealing at least one of the plenum channel and a flow channel in at least one of the first insert layer and the first frame layer;
a first impermeable electrically conductive layer positioned adjacent to and in contact with the first insert layer, the first impermeable electrically conductive layer configured to seal and enclose at least one of the first and the second lateral flow channel in the first insert layer;
an Nth frame layer, where N is equal to the number of electrochemical cells in the stack;
a second base layer positioned adjacent to and in contact with the Nth frame layer;
a second structural end plate positioned adjacent to and in contact with the second base layer.
